(19) United States
(12) Patent Application Publication
(10) Pub. No.: US 2016/0243478 A1
(43) Pub. Date: Aug. 25, 2016

(54) FILTER COMPRISING NANOFIBER AND METHOD FOR MANUFACTURING SAME

(71) Applicant: FINETEX ENE, INC., Seoul (KR)

(72) Inventor: Jong-Chul PARK, Seoul (KR)

(73) Assignee: FINETEX ENE, INC., Seoul (KR)

(21) Appl. No.: 15/027,356

(22) PCT Filed: Feb. 26, 2014
(86) PCT No.: PCT/KR2014/001575

§ 371 Date: Apr. 5, 2016

(30) Foreign Application Priority Data
Oct. 7, 2013 (KR) 1020130119472
Oct. 7, 2013 (KR) 1020130119473
Oct. 7, 2013 (KR) 1020130119474
Oct. 7, 2013 (KR) 1020130119475
Oct. 7, 2013 (KR) 1020130119476
Oct. 7, 2013 (KR) 1020130119477
Oct. 7, 2013 (KR) 1020130119478
Oct. 7, 2013 (KR) 1020130119479
Oct. 7, 2013 (KR) 1020130119480
Oct. 7, 2013 (KR) 1020130119481
Oct. 7, 2013 (KR) 1020130119482
Oct. 7, 2013 (KR) 1020130119483
Oct. 7, 2013 (KR) 1020130119484

(51) Int. Cl. B01D 39/16; D01D 5/00; D04H 1/728; B01D 39/18

(52) U.S. Cl. CPC B01D 39/1623; B01D 39/18; D01D 5/0023; D01D 5/0084; D04H 1/728; D04H 1/4318

(57) ABSTRACT

The purpose of the present invention is to provide a filter comprising nanofiber and a method for manufacturing the same, and the present invention relates to a filter manufactured by continuously forming spinning solution by means of an electrospinning apparatus comprising at least two units, and a method for manufacturing the same. A filter manufactured by the method is advantageous in that manufacturing process can be made continuous, thereby making process efficient and enabling mass production, and is characterized in that, by having nanofiber non-woven fabric a filter having excellent filtering efficiency is manufactured.

### TECHNICAL FIELD

The present invention relates to a filter comprising nanofiber and method for manufacturing the same, and more particularly, to a filter comprising nanofiber produced by electrospinning polymer spinning solution on a substrate, and method for manufacturing the same.

### BACKGROUND ART

Generally, a filter is a filtering medium which filters out foreign matter in fluid, and comprises a liquid filter and an air filter. An air filter is used for prevention of defective high-tech products along with high-tech industry development. An air filter eliminates biologically harmful things such as dust in air, particles, bio particles such as virus and mold, bacteria, etc. An air filter is applied in various fields such as production of semiconductor, assembly of computing device, hospital, food processing plant, food and agriculture field, and also widely used in workplace with a lot of dust, and thermoelectric power plant. Gas turbine used in thermal power plant intakes purified air from outside, compresses it, injects compressed air with fuel to combustion burner, mixes them, combusts mixed air and fuel, obtains high temperature and high pressure combustion gas, injects the high temperature and high pressure combustion gas to vane of turbine, and attains rotatory power. Since the gas turbine comprises very precise components, periodic planned preventive maintenance is performed, and wherein the air filter is used for pretreatment to purify air in the atmosphere which inflows to a compressor.

Here, when an air filter adopts air for combustion intake to gas turbine, stop from permeating foreign substances in atmosphere such as dust into a filter medium, and provides purified air. However, particles with larger particle size form Filter Cake on the surface of the filter medium. Also, fine particles gradually accumulate in the filter medium, and block gas hole of the filter medium. Eventually, when particles accumulate on the surface of filter medium, it increases pressure loss of a filter, and decline sustainability of a filter.

Meanwhile, conventional air filter provides static electricity to fiber-assembly comprising a filter medium, and measures efficiency according to the principle collecting by electrostatic force. However, the Europe air filter standard classification EN779 is revised recently to eliminate efficiency of filter by static electricity effect in 2012 and revealed that conventional filter actual efficiency decreases 20% or more.

In order to solve the problems stated above, various methods which apply to filter by producing nanosize fiber have been developed and used. A nanofilter realized with nanofiber to filter, in comparison with to conventional filter medium having large diameter, specific-surface area is very large, flexibility of surface functionality is good, gas hole size has nano level, and harmful fine particles are effectively eliminated. However, realization of filter using nanofiber has problems such as increasing production cost, difficulty in adjusting various conditions for production, difficulty in mass-production, and filter using nanofiber could not be produced and distributed in relatively low unit cost. Also, since conventional technology of spinning nanofiber is limited to small scale production line concentrating on laboratory, there is no case of introduction of spinning-section as unit concept.

### DISCLOSURE

### Technical Problem

The present invention is contrived to solve the problems stated above, the present invention relates to a filter comprising nanofiber non-woven fabric laminating formed by electrospinning polymer spinning solution on a substrate and its manufacturing method. The present invention provides a filter and its manufacturing method that can have less pressure lose than conventional filter, increase filtering efficiency, and extend filter sustainability.

Moreover, the present invention is directed to providing a filter produced by introducing unit concept in electrospinning, which can mass-produce, and produces filter with uniformed quality.

### Technical Solution

According to an exemplary embodiment of the present invention, the filter comprises a cellulose substrate and polyvinylidene fluoride nanofiber non-woven fabric laminating formed on the cellulose substrate by electrospinning polyvinylidene fluoride solution, and features thermosetting of the cellulose substrate and the polyvinylidene fluoride nanofiber non-woven fabric.

According to another exemplary embodiment of the present invention, the filter comprises nanofiber that polyvinylidene fluoride nanofiber non-woven fabric includes a first polyvinylidene fluoride nanofiber non-woven fabric layer with fiber diameter of 150 to 300 nm and a second polyvinylidene fluoride nanofiber non-woven fabric layer with fiber diameter of 100 to 150 nm laminating formed on the first polyvinylidene fluoride nanofiber non-woven by electrospinning.

According to yet another exemplary embodiment of the present invention, hot-melt electrospinning layer is provided between a cellulose substrate and the polyvinylidene fluoride nanofiber non-woven fabric.

According to another exemplary embodiment of the present invention, polyvinylidene fluoride nanofiber non-woven fabric is produced by solution which mixed polyvinylidene fluoride and hot-melt.

According to yet another exemplary embodiment of the present invention, the filter comprising nanofiber is laminated and electrospinned polyvinylidene fluoride solution on polyvinylidene fluoride-hot-melt nanofiber non-woven fabric produced by solution mixed polyvinylidene fluoride and hot-melt. Here, hot-melt is preferably polyvinylidene fluoride group hot-melt.

According to another exemplary embodiment of the present invention, the cellulose substrate comprises cellulose and polyethylene terephthalate.

According to yet another exemplary embodiment of the present invention, composition rate of cellulose substrate is the cellulose 70 to 90 weight % and the polyethylene terephthalate 10 to 30 weight %.

According to another exemplary embodiment of the present invention, the cellulose substrate is coated with a flame resistant.

According to yet another exemplary embodiment of the present invention, the filter comprising nanofiber comprises a bicomponent substrate and polyvinylidene fluoride nanofiber non-woven fabric laminated by electrospinning polyvinylidene fluoride solution on the bicomponent substrate, and the bicomponent substrate and the polyvinylidene fluoride nanofiber non-woven fabric is thermosetted each other.

According to another exemplary embodiment of the present invention, the filter comprising nanofiber comprises a substrate and nanofiber non-woven fabric laminated by electrospinning solution mixed polyvinylidene fluoride and polyurethane on the substrate, and the substrate and the nanofiber non-woven fabric is thermosetted each other.

According to yet another exemplary embodiment of the present invention, the filer comprising nanofiber comprises a substrate, polyurethane nanofiber non-woven fabric laminated by electrospinning on the substrate, and polyvinylidene fluoride nanofiber non-woven fabric laminated by electrospinning on the polyurethane nanofiber non-woven fabric, and the polyurethane nanofiber non-woven fabric and the polyvinylidene fluoride nanofiber non-woven fabric is thermosetted each other.

According to another example embodiment of the present invention, the filter comprising nanofiber comprises a substrate, nylon nanofiber non-woven fabric with fiber diameter of 100 to 150 nm on the substrate, and polyvinylidene fluoride nanofiber non-woven fabric with fiber diameter of 80 to 150 nm laminated by electrospinning on the nylon nanofiber non-woven fabric.

According to yet another exemplary embodiment of the present invention, the filter comprising nanofiber comprises a substrate, low melting point polyvinylidene fluoride nanofiber non-woven fabric laminated by electrospinning on the substrate, and high melting point polyvinylidene fluoride nanofiber non-woven fabric laminated by electrospinning on the low melting point polyvinylidene fluoride nanofiber non-woven fabric, the substrate, the low melting point polyvinylidene fluoride nanofiber non-woven fabric, and the high melting point polyvinylidene fluoride nanofiber non-woven fabric are thermosetted each other.

According to another exemplary embodiment of the present invention, the filter comprising nanofiber comprises a polyethylene terephthalate substrate, a first polyvinylidene fluoride nanofiber non-woven fabric with fiber diameter of 200 to 250 nm laminated by electrospinning on the polyethylene terephthalate substrate, a second polyvinylidene fluoride nanofiber non-woven fabric with fiber diameter of 150 to 200 nm laminated by electrospinning on the first polyvinylidene fluoride nanofiber non-woven fabric, and a third polyvinylidene fluoride with fiber diameter of 100 to 150 nm laminated by electrospinning on the second polyvinylidene fluoride nanofiber non-woven fabric.

According to yet another exemplary embodiment of the present invention, the filter comprising nanofiber comprises a polyethylene terephthalate substrate, a bicomponent substrate laminated on the polyethylene terephthalate substrate, and nylon nanofiber non-woven fabric laminated by electrospinning on the bicomponent substrate, and the polyethylene terephthalate substrate, the bicomponent substrate, and the nylon nanofiber non-woven fabric are thermosetted each other.

According to another exemplary embodiment of the present invention, the filter comprising nanofiber comprises a polyethylene terephthalate substrate, a bicomponent substrate laminated on the polyethylene terephthalate substrate, and polyvinylidene fluoride nanofiber non-woven fabric laminated by electrospinning on the bicomponent substrate, and the polyethylene terephthalate substrate, the bicomponent substrate, and the polyvinylidene fluoride nanofiber non-woven fabric are thermosetted each other.

According to yet another exemplary embodiment of the present invention, the filter comprising nanofiber comprises a polyethylene terephthalate substrate, a bicomponent substrate laminated on the polyethylene terephthalate substrate, high melting point and low melting point polyvinylidene fluoride nanofiber non-woven fabric laminated by electrospinning solution mixed high melting point polyvinylidene fluoride and low melting point polyvinylidene fluoride on the bicomponent substrate, and the polyethylene terephthalate substrate, the bicomponent substrate, and the high melting point and low melting point polyvinylidene fluoride nanofiber non-woven fabric are thermosetted each other.

According to another exemplary embodiment of the present invention, the polyethylene terephthalate substrate comprises needle felt type polyethylene terephthalate substrate.

According to yet another exemplary embodiment of the present invention, the filter comprising nanofiber comprises a first bicomponent substrate, polyvinylidene fluoride nanofiber non-woven fabric laminated by electrospinning on one side of the first bicomponent substrate, and a second bicomponent substrate adhered on another side of the first bicomponent substrate and not adhered the polyvinylidene fluoride nanofiber non-woven fabric, and the polyvinylidene fluoride nanofiber non-woven fabric, the first bicomponent substrate, and the second bicomponent substrate are thermosetted each other.

According to another exemplary embodiment of the present invention, the filter comprising nanofiber comprises a first polyethylene terephthalate substrate, a first polyvinylidene fluoride nanofiber non-woven fabric with fiber diameter of 150 to 300 nm laminated by electrospinning polyvinylidene fluoride solution on one side of the first polyethylene terephthalate substrate, a second polyvinylidene fluoride nanofiber non-woven fabric with fiber diameter of 100 to 150 nm laminated by electrospinning polyvinylidene fluoride solution on the first polyvinylidene fluoride nanofiber non-woven fabric, and a second polyethylene terephthalate substrate adhered on another side of the first polyethylene terephthalate substrate and not adhered the first polyvinylidene fluoride nanofiber non-woven fabric, and thermosetting of the first polyethylene terephthalate substrate, the second polyethylene terephthalate substrate, the first polyvinylidene fluoride nanofiber non-woven fabric, and the second polyvinylidene fluoride nanofiber non-woven fabric are thermosetted each other.

According to yet another exemplary embodiment of the present invention, the filter comprising nanofiber comprises a polyethylene terephthalate substrate, a bicomponent substrate laminated on the polyethylene terephthalate substrate, polyvinylidene fluoride nanofiber non-woven fabric laminated by electrospinning on the bicomponent substrate, and meltblown non-woven fabric laminated on the polyvinylidene fluoride nanofiber non-woven fabric, and the polyethylene terephthalate substrate, the bicomponent substrate, the polyvinylidene fluoride nanofiber non-woven fabric, and meltblown non-woven fabric are thermosetted each other.

According to another exemplary embodiment of the present invention, by the electrospinning apparatus comprises 2 or more units, spinning solution main tank is independently connected and installed in nozzle of nozzle block located in each unit, and polymer spinning solution is spinned on a substrate located in a collector of each unit, method for manufacturing filter comprising nanofiber comprises a step of inserting polyvinylidene fluoride solution which dissolved polyvinylidene fluoride in solvent to spinning solution main tank of each unit, a step of laminating-forming polyvinylidene fluoride nanofiber non-woven fabric by consecutively electrospinning the polyvinylidene fluoride solution in nozzle of each of the unit on a cellulose substrate, and a step of thermosetting the cellulose substrate and the polyvinylidene fluoride nanofiber non-woven fabric.

According to yet another exemplary embodiment of the present invention, the step of laminating-forming the polyvinylidene fluoride nanofiber non-woven fabric comprises a step of laminating-forming a first polyvinylidene fluoride nanofiber non-woven fabric with fiber diameter of 150 to 300 nm in a first unit of the electrospinning apparatus and a step of laminating-forming a second polyvinylidene fluoride nanofiber non-woven fabric with fiber diameter of 100 to 150 nm in a second unit of the electrospinning apparatus.

According to another exemplary embodiment of the present invention, the polyvinylidene fluoride solution includes producing solution mixed polyvinylidene fluoride and hot-melt.

According to yet another exemplary embodiment of the present invention, the method for manufacturing filter comprising nanofiber comprises a step of laminating-forming the polyvinylidene fluoride nanofiber non-woven fabric including a step of forming polyvinylidene fluoride-hot-melt nanofiber non-woven fabric by electrospinning solution mixed polyvinylidene fluoride and hot-melt on a cellulose substrate in a first unit of the electrospinning apparatus and a step of laminating-forming polyvinylidene fluoride nanofiber non-woven fabric by electrospinning polyvinylidene fluoride solution on the polyvinylidene fluoride-hot-melt nanofiber non-woven fabric in a second unit of the electrospinning apparatus. Here, the hot-melt is preferably polyvinylidene fluoride group.

According to another exemplary embodiment of the present invention, by the electrospinning apparatus comprises 2 or more units, spinning solution main tank is independently connected and installed in nozzle of nozzle block located in each unit, and polymer spinning solution is spinned on a substrate located in a collector of each unit, method for manufacturing filter comprising nanofiber comprises a step of inserting hot-melt solution which dissolved hot-melt in solvent to a spinning solution main tank of a first unit and inserting polyvinylidene fluoride solution which dissolved polyvinylidene fluoride in solvent to a spinning solution main tank of a second unit of the electrospinning apparatus, a step of laminating-forming hot-melt electrospinning layer by electrospinning hot-melt solution on a cellulose substrate in the first unit, a step of laminating-forming polyvinylidene fluoride nanofiber non-woven fabric by consecutively electrospinning polyvinylidene fluoride solution on the hot-melt electrospinning layer in the second unit, and a step of thermosetting the cellulose substrate, the hot-melt electrospinning layer, and the polyvinylidene fluoride nanofiber non-woven fabric. Here, the hot-melt is preferably polyvinylidene fluoride group hot-melt.

According to yet another exemplary embodiment of the present invention, by the electrospinning apparatus comprises 2 or more units, spinning solution main tank is independently connected and installed in nozzle of nozzle block located in each unit, and polymer spinning solution is spinned on a substrate located in a collector of each unit, method for manufacturing filter comprising nanofiber comprises a step of inserting polyvinylidene fluoride solution which dissolved polyvinylidene fluoride in solvent to a spinning solution main tank of each unit, a step of laminating forming polyvinylidene fluoride nanofiber non-woven fabric by consecutively electrospinning the polyvinylidene fluoride solution in nozzle of each of the nozzle on a bicomponent substrate, and a step of thermosetting the bicomponent substrate and the polyvinylidene fluoride nanofiber non-woven fabric.

According to another exemplary embodiment of the present invention, the manufacturing method for manufacturing filter comprising nanofiber comprises a step of producing spinning solution which mixed polyvinylidene fluoride and polyurethane, a step of laminating-forming nanofiber non-woven fabric by electrospinning the spinning solution on a substrate, and a step of thermosetting the substrate and the nanofiber non-woven fabric.

According to yet another exemplary embodiment of the present invention, the manufacturing method manufacturing for filter comprising nanofiber comprises a step of producing polyvinylidene fluoride solution and polyurethane solution, a step of laminating-forming polyurethane nanofiber non-woven fabric by electrospinning the polyurethane solution on a substrate in a first unit of the electrospinning apparatus, a step of laminating-forming polyvinylidene fluoride nanofiber non-woven fabric by electrospinning the polyvinylidene fluoride solution on the polyurethane nanofiber non-woven fabric in a second unit of the electrospinning apparatus, and a step of thermosetting the substrate, the polyurethane nanofiber non-woven fabric, and the polyvinylidene fluoride nanofiber non-woven fabric.

According to yet another exemplary embodiment of the present invention, by the electrospinning apparatus comprises 2 or more units, spinning solution main tank is independently connected and installed in nozzle of nozzle block located in each unit, and polymer spinning solution is spinned on a substrate located in a collector of each unit, method for manufacturing filter comprising nanofiber comprises a step of producing nylon solution by dissolving nylon in solvent and producing polyvinylidene fluoride solution by dissolving polyvinylidene fluoride in solvent, a step of laminating-forming nylon nanofiber non-woven fabric with fiber diameter of 100 to 150 nm by electrospinning the nylon solution on a substrate in a first unit of the electrospinning apparatus, a step of laminating-forming polyvinylidene fluoride nanofiber non-woven fabric with fiber diameter of 80 to 150 nm by electrospinning the polyvinylidene fluoride solution on the nylon nanofiber non-woven fabric in a second unit of the electrospinning apparatus, a step of thermosetting the substrate, the nylon nanofiber non-woven fabric, and the polyvinylidene fluoride nanofiber non-woven fabric.

According to yet another exemplary embodiment of the present invention, by the electrospinning apparatus comprises 2 or more units, spinning solution main tank is independently connected and installed in nozzle of nozzle block located in each unit, and polymer spinning solution is spinned on a substrate located in a collector of each unit, method for manufacturing filter comprising nanofiber comprises a step of producing high melting point polyvinylidene fluoride solution by dissolving high melting point polyvinylidene fluoride in solvent and producing low melting point polyvinylidene fluoride solution by dissolving low melting point polyvinylidene fluoride in solvent, a step of laminating-forming low melting point polyvinylidene fluoride nanofiber non-woven fabric by electrospinning the low melting point polyvinylidene fluoride solution on a substrate in a first unit of the electrospinning apparatus, a step of laminating-forming high melting point polyvinylidene fluoride nanofiber non-woven fabric by electrospinning the high melting point polyvinylidene fluoride solution on the low melting point polyvinylidene fluoride nanofiber non-woven fabric in a second unit of the electrospinning apparatus, and a step of thermosetting the substrate, the low melting point polyvinylidene fluoride nanofiber non-woven fabric, and the high melting point polyvinylidene fluoride nanofiber non-woven fabric.

According to another exemplary embodiment of the present invention, by the electrospinning apparatus comprises 2 or more units, spinning solution main tank is independently connected and installed in nozzle of nozzle block located in each unit, and polymer spinning solution is spinned on a substrate located in a collector of each unit, method for manufacturing filter comprising nanofiber comprises a step of producing polyvinylidene fluoride solution by dissolving polyvinylidene fluoride in solvent, a step of laminating-forming a first polyvinylidene fluoride nanofiber non-woven fabric with fiber diameter of 200 to 250 nm by electrospinning the polyvinylidene fluoride solution on a substrate, a step of laminating-forming a second polyvinylidene fluoride nanofiber non-woven fabric of fiber diameter of 150 to 200 nm by electrospinning the polyvinylidene fluoride solution on the first polyvinylidene fluoride nanofiber non-woven fabric, and a step of laminating-forming a third polyvinylidene fluoride nanofiber non-woven fabric of fiber diameter of 100 to 150 nm by electrospinning the polyvinylidene fluoride solution on the second polyvinylidene fluoride nanofiber non-woven fabric.

According to yet another exemplary embodiment of the present invention, by the electrospinning apparatus comprises 2 or more units, spinning solution main tank is independently connected and installed in nozzle of nozzle block located in each unit, and polymer spinning solution is spinned on a substrate located in a collector of each unit, method for manufacturing filter comprising nanofiber comprises a step of inserting nylon solution which dissolved nylon in solvent to a spinning solution main tank of each unit, a step of laminating-forming nylon nanofiber non-woven fabric by electrospinning the nylon solution on one side of a bicomponent substrate in nozzle of each of the unit, a step of bonding polyethylene terephthalate substrate on another side of the bicomponent substrate which is not adhered to the nylon nanofiber non-woven fabric, and a step of thermosetting the nylon nanofiber non-woven fabric, the bicomponent substrate, and the polyethylene terephthalate substrate.

According to another exemplary embodiment of the present invention, by the electrospinning apparatus comprises 2 or more units, spinning solution main tank is independently connected and installed in nozzle of nozzle block located in each unit, and polymer spinning solution is spinned on a substrate located in a collector of each unit, method for manufacturing filter comprising nanofiber comprises a step of inserting polyvinylidene fluoride solution which dissolved polyvinylidene fluoride in solvent to spinning solution main tank of each unit, a step of laminating-forming polyvinylidene fluoride nanofiber non-woven fabric by electrospinning the polyvinylidene fluoride solution on one side of a bicomponent substrate in nozzle of each of the unit, a step of bonding polyethylene terephthalate substrate on another side of the bicomponent substrate not adhered to the polyvinylidene fluoride nanofiber non-woven fabric, and a step of thermosetting the polyvinylidene fluoride nanofiber non-woven fabric, the bicomponent substrate, and the polyethylene terephthalate substrate.

According to yet another exemplary embodiment of the present invention, by the electrospinning apparatus comprises 2 or more units, spinning solution main tank is independently connected and installed in nozzle of nozzle block located in each unit, and polymer spinning solution is spinned on a substrate located in a collector of each unit, method for manufacturing filter comprising nanofiber comprises a step of producing polyvinylidene fluoride solution which dissolved high melting point polyvinylidene fluoride and low melting point polyvinylidene fluoride in solvent, a step of laminating-forming high melting point and low melting point polyvinylidene fluoride nanofiber non-woven fabric by electrospinning the polyvinylidene fluoride solution on a bicomponent substrate, a step of bonding polyethylene terephthalate substrate on another side of the bicomponent substrate, and a step of thermosetting the high melting point and low melting point polyvinylidene fluoride nanofiber non-woven fabric, the bicomponent substrate, and the polyethylene terephthalate substrate.

Here, the polyethylene terephthalate substrate includes needle felt type polyethylene terephthalate substrate.

According to another exemplary embodiment of the present invention, by the electrospinning apparatus comprises 2 or more units, spinning solution main tank is independently connected and installed in nozzle of nozzle block located in each unit, and polymer spinning solution is spinned on a substrate located in a collector of each unit, method for manufacturing filter comprising nanofiber comprises a step of inserting polyvinylidene fluoride solution which dissolved polyvinylidene fluoride in solvent to spinning solution main tank of each unit, a step of laminating-forming polyvinylidene fluoride nanofiber non-woven fabric by electrospinning the polyvinylidene fluoride solution on one side of a first bicomponent substrate in nozzle of each of the unit, a step of bonding a second bicomponent substrate on another side of the first bicomponent substrate not adhered to the polyvinylidene fluoride nanofiber non-woven fabric, and a step of thermosetting the polyvinylidene fluoride nanofiber non-woven fabric, the first bicomponent substrate, and the second bicomponent substrate.

According to yet another exemplary embodiment of the present invention, by the electrospinning apparatus comprises 2 or more units, spinning solution main tank is independently connected and installed in nozzle of nozzle block located in each unit, and polymer spinning solution is spinned on a substrate located in a collector of each unit, method for manufacturing filter comprising nanofiber comprises a step of inserting polyvinylidene fluoride solution which dissolved polyvinylidene fluoride in solvent to spinning solution main tank of each unit, a step of laminating-forming a first polyvinylidene fluoride nanofiber non-woven fabric of fiber diameter of 150 to 300 nm by electrospinning the polyvinylidene fluoride solution on one side of a first polyethylene terephthalate substrate in a first unit of the electrospinning apparatus, a step of laminating-forming a second polyvinylidene fluoride nanofiber non-woven fabric of fiber diameter of 100 to 150 nm by electrospinning the polyvinylidene fluoride solution on the first polyvinylidene fluoride nanofiber non-woven fabric in a second unit of the electrospinning apparatus, a step of bonding a second polyethylene terephthalate substrate on another side of the first polyethylene terephthalate substrate not adhered with the first polyvinylidene fluoride nanofiber non-woven fabric, a step of thermosetting the first polyethylene terephthalate substrate, the second polyethylene terephthalate substrate, the first polyvinylidene fluoride nanofiber non-woven fabric, and the second polyvinylidene fluoride nanofiber non-woven fabric.

According to another exemplary embodiment of the present invention, by the electrospinning apparatus comprises 2 or more units, spinning solution main tank is independently connected and installed in nozzle of nozzle block located in each unit, and polymer spinning solution is spinned on a substrate located in a collector of each unit, method for manufacturing filter comprising nanofiber comprises a step of producing polyvinylidene fluoride solution which dissolved polyvinylidene fluoride in solvent, a step of laminating-forming polyvinylidene fluoride nanofiber non-woven fabric by electrospinning the polyvinylidene fluoride solution on one side of a bicomponent substrate, a step of bonding polyethylene terephthalate substrate on another side of the bicomponent substrate and bonding meltblown non-woven fabric on the polyvinylidene fluoride nanofiber non-woven fabric.

### Advantageous Effects

The filter according to the exemplary embodiment of the present invention by laminating-forming nanofiber non-woven fabric on a filter substrate, compared to conventional filter, is capable of lessening pressure lose, enhancing filter efficiency, and extending filter sustainability.

Moreover, the electrospinning apparatus manufacturing a filter of the present invention comprises at least 2 or more units and it is possible to consecutively electrospinning, thereby having an effect of mass-producing filter using nanofiber.

### BRIEF DESCRIPTION OF THE DRAWINGS

FIG. 1 schematically shows a side view of an electrospinning apparatus according to an exemplary embodiment of the present invention.

FIG. 2 schematically illustrates a side view of nozzle of a nozzle block installed in each unit of the electrospinning apparatus according to an exemplary embodiment of the present invention.

FIG. 3 schematically illustrates a side view of nozzle of a nozzle block installed in each unit of the electrospinning apparatus according to another exemplary embodiment of the present invention.

FIG. 4 schematically depicts a top plan view of a nozzle block installed in each unit of the electrospinning apparatus according to an exemplary embodiment of the present invention.

FIG. 5 schematically shows a front sectional view of heat transfer device in a nozzle block installed in each unit of the electrospinning apparatus according to an exemplary embodiment of the present invention.

FIG. 6 is a cross-sectional view of A-A′line according to an exemplary embodiment of the present invention.

FIG. 7 schematically shows a front sectional view of heat transfer device in a nozzle block installed in each unit of the electrospinning apparatus according to another exemplary embodiment of the present invention.

FIG. 8 shows a cross-sectional view of B-B′line according to an exemplary embodiment of the present invention.

FIG. 9 schematically shows a front sectional view of heat transfer device in a nozzle block installed in each unit of the electrospinning apparatus according to the other exemplary embodiment of the present invention.

FIG. 10 shows a cross-sectional view of C-C′line according to an exemplary embodiment of the present invention.

FIG. 11 schematically illustrates a view of an auxiliary carry device of the electrospinning apparatus according to an exemplary embodiment of the present invention.

FIG. 12 schematically illustrates a view of an auxiliary belt roller of an auxiliary carry device of the electrospinning apparatus according to another exemplary embodiment of the present invention.

FIG. 13 to FIG. 16 schematically illustrate a side view of operation process of an elongated sheet carry speed adjusting device of the electrospinning apparatus according to an exemplary embodiment of the present invention.

FIG. 17 schematically shows a view of a filter comprising polyvinylidene fluoride nanofiber non-woven fabric on a cellulose substrate according to an exemplary embodiment of the present invention.

FIG. 18 schematically shows a view of a filter comprising polyvinylidene fluoride nanofiber non-woven fabric on a bicomponent substrate according to an exemplary embodiment of the present invention.

FIG. 19 schematically shows a view of a filter comprising polyurethane and polyvinylidene fluoride nanofiber non-woven fabric on a substrate according to an exemplary embodiment of the present invention.

FIG. 20 schematically depicts a view of a filter comprising polyurethane nanofiber non-woven fabric and polyvinylidene fluoride nanofiber non-woven fabric on a substrate according to an exemplary embodiment of the present invention.

FIG. 21 schematically depicts a view of a filter comprising nylon nanofiber non-woven fabric and polyvinylidene fluoride nanofiber non-woven fabric on a substrate according to an exemplary embodiment of the present invention.

FIG. 22 schematically depicts a view of a filter comprising low melting point polyvinylidene fluoride nanofiber non-woven fabric and high melting point polyvinylidene fluoride nanofiber non-woven fabric on a substrate according to an exemplary embodiment of the present invention.

FIG. 23 schematically illustrates a side view of an electrospinning apparatus according to an exemplary embodiment of the present invention.

FIG. 24 schematically shows a view of a filter comprising a first, a second, a third polyvinylidene fluoride nanofiber non-woven fabric according to an exemplary embodiment of the present invention.

FIG. 25 schematically illustrates a side view of an electrospinning apparatus according to another exemplary embodiment of the present invention.

FIG. 26 schematically shows a view of a filter comprising nylon nanofiber non-woven fabric laminated on a bicomponent substrate which is laminated on a PET substrate according to an exemplary embodiment of the present invention.

FIG. 27 schematically shows a view of a filter comprising polyvinylidene fluoride nanofiber non-woven fabric laminated on a bicomponent substrate which is laminated on a PET substrate according to an exemplary embodiment of the present invention.

FIG. 28 schematically shows a view of a filter comprising high melting point and low melting point polyvinylidene fluoride nanofiber non-woven fabric laminated on a bicomponent substrate which is laminated on a PET substrate according to an exemplary embodiment of the present invention.

FIG. 29 schematically shows a view of a filter comprising high melting point and low melting point polyvinylidene fluoride nanofiber non-woven fabric laminated on a bicomponent substrate which is laminated on a needle felt type PET substrate according to an exemplary embodiment of the present invention.

FIG. 30 schematically shows a view of a filter comprising polyvinylidene fluoride nanofiber non-woven fabric laminated on a first bicomponent substrate which is laminated on a second bicomponent substrate according to an exemplary embodiment of the present invention.

FIG. 31 schematically shows a view of a filter comprising a first and a second polyvinylidene fluoride nanofiber non-woven fabric laminated on a first PET substrate which is laminated on a second PET substrate according to an exemplary embodiment of the present invention.

FIG. 32 schematically illustrates a side view of an electrospinning apparatus according to the other exemplary embodiment of the present invention.

FIG. 33 schematically illustrates a view of a filter comprising polyvinylidene fluoride nanofiber non-woven fabric and meltblown non-woven fabric laminated on a bicomponent substrate which is laminated on a PET substrate according to an exemplary embodiment of the present invention.

### DESCRIPTION OF REFERENCE NUMBERS OF DRAWINGS

1, 1′, 1″, 1″′: electrospinning apparatus,
3: supply roller,
5: winding roller,
7: main control device,
8: spinning solution main tank,
10a, 10b, 10c: unit,
11: nozzle block,
12: nozzle,
13: collector,
14, 14a, 14b, 14c: voltage generator,
15, 15a, 15b: elongated sheet,
16: auxiliary carry device,
16a: auxiliary belt,
16b: auxiliary belt roller,
18: case,
19: insulation member,
30: elongated sheet carry speed adjusting device,
31: buffer section,
33, 33′: support roller,
35: adjusting roller,
40: pipe,
41, 42: heat line,
43: pipe,
60: temperature adjusting control device,
70: thickness measurement device,
80: permeability measuring device,
90: laminating device,
100: laminating device,
200: overflow device,
211, 231: agitation device,
212, 213, 214, 233: valve,
216: second feed pipe,
218: second feed control device,
220: middle tank,
222: second sensor,
230: recycled tank,
232: first sensor,
240: supply pipe,
242: supply control valve,
250: spinning solution return path,
251: first feed pipe,
300: VOC recycling device,
310: condensation device,
311, 321, 331, 332: pipe,
320: distillation device,
330: solvent storage device,
404: nozzle for air supply,
405: nozzle plate,
407: first spinning solution storage plate,
408: second spinning solution storage plate,
410: overflow solution temporal storage plate,
411: air storage plate,
412: overflow outlet,
413: air inlet,
414: nozzle support plate for air supply,
415: nozzle for overflow removal,
416: nozzle plate for overflow removal,
500: multi-tubular nozzle,
501: inner tube,
502: outer tube,
503: front-end

### DETAILED DESCRIPTION OF THE PREFERRED EMBODIMENTS

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

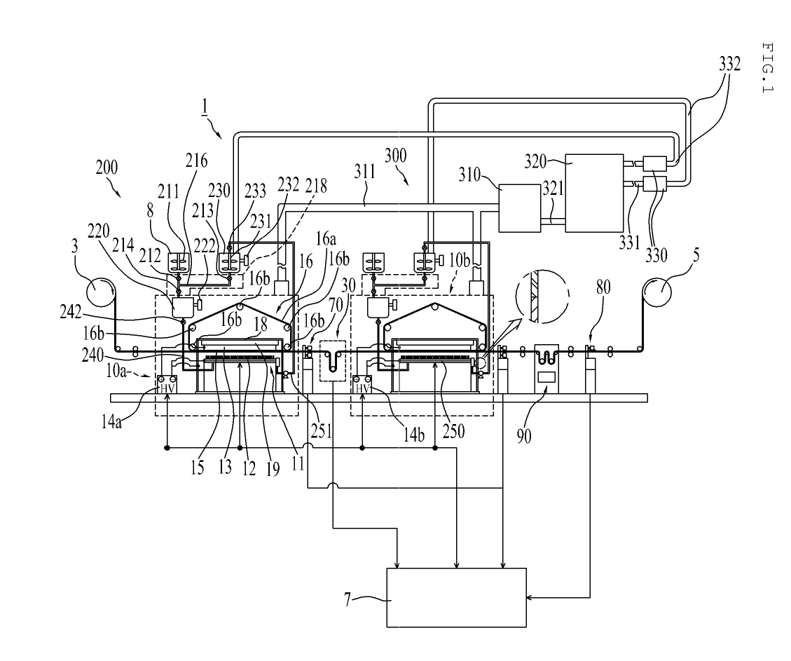

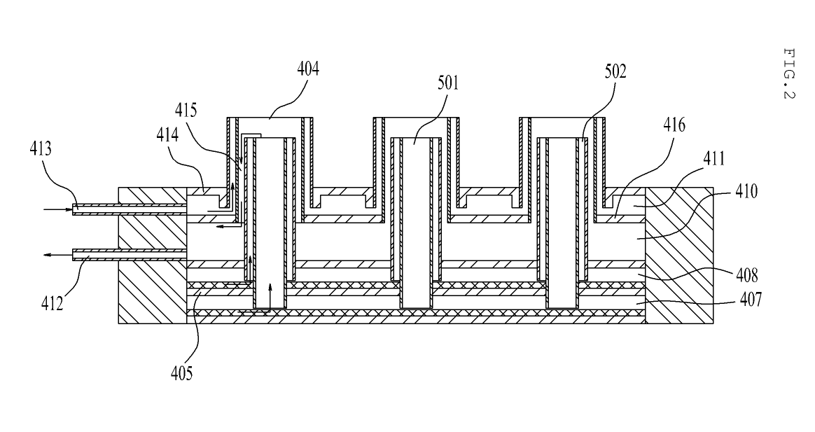

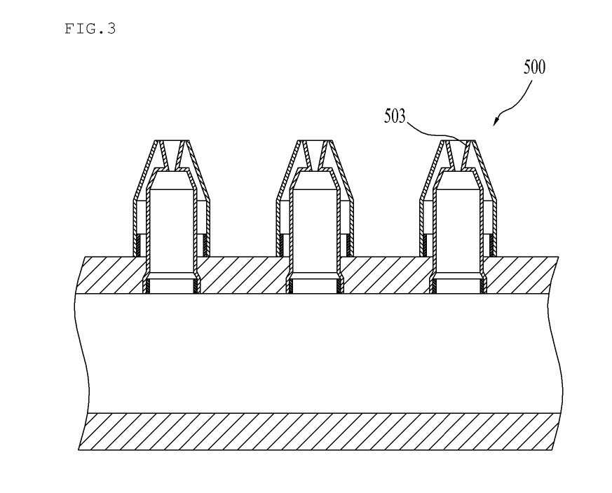

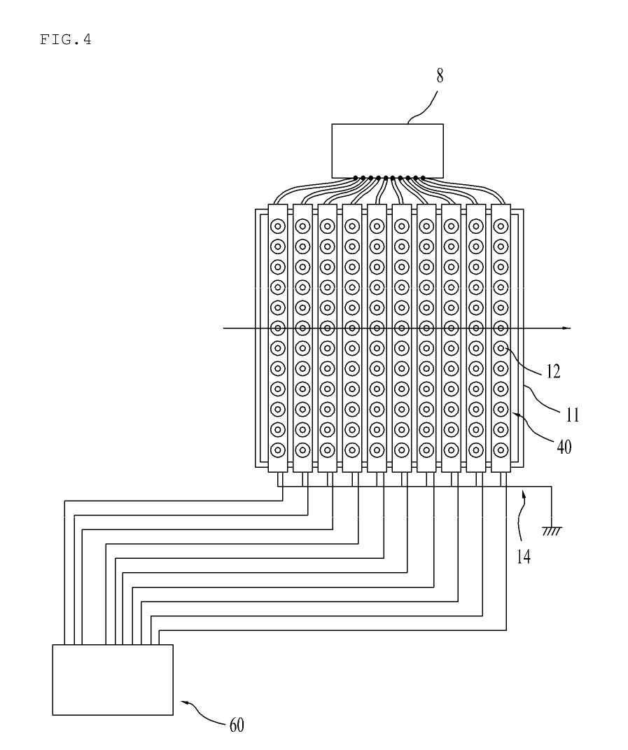

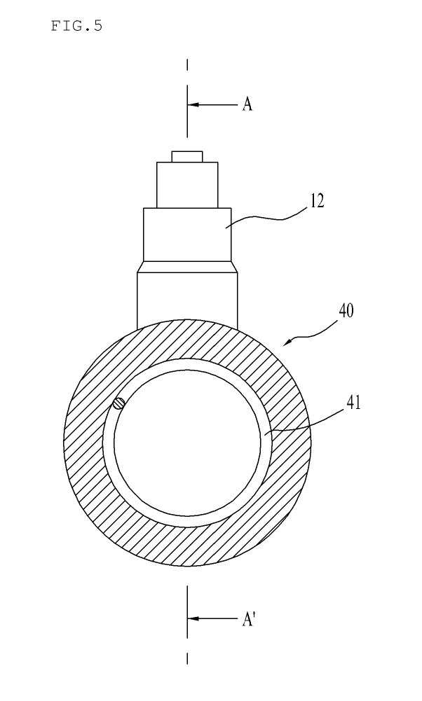

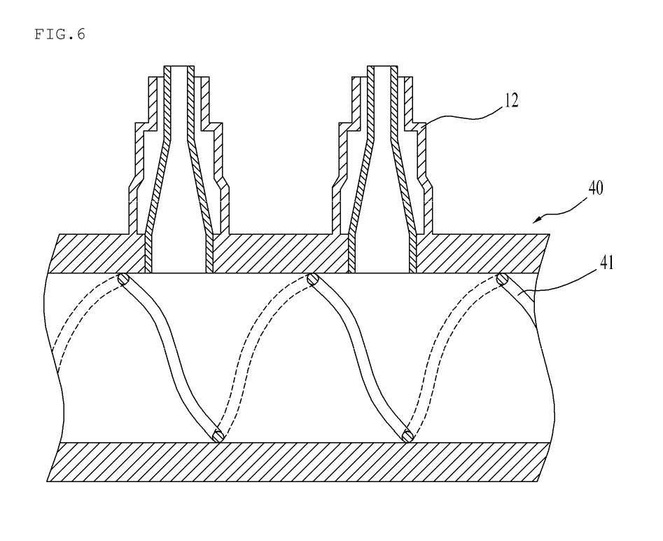

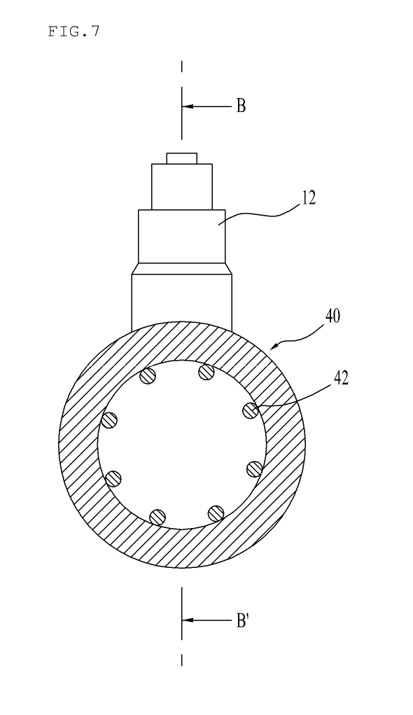

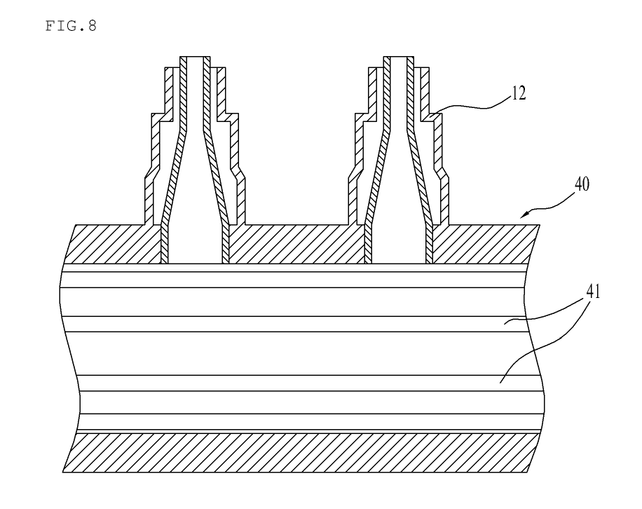

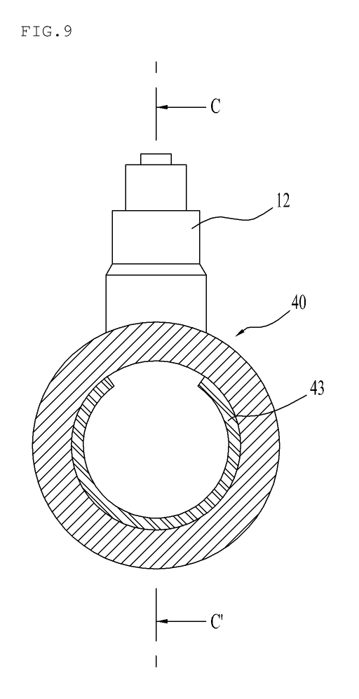

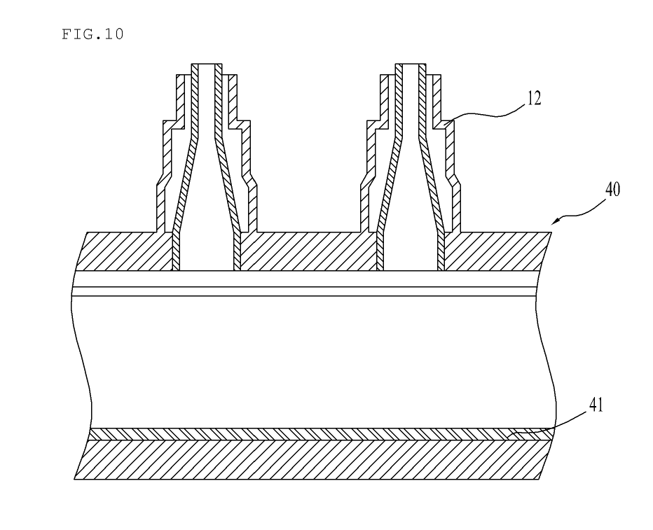

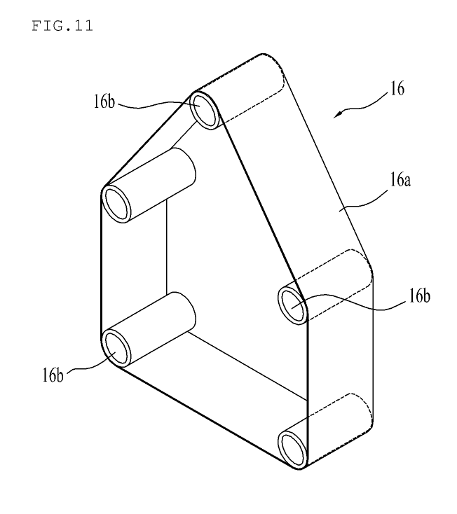

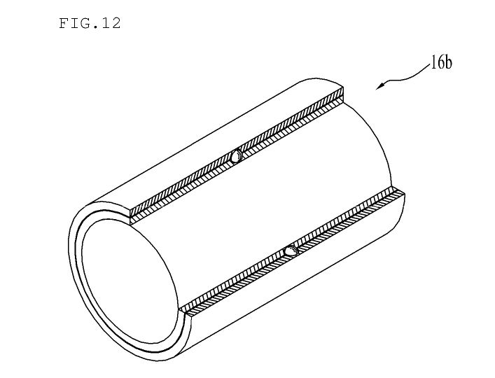

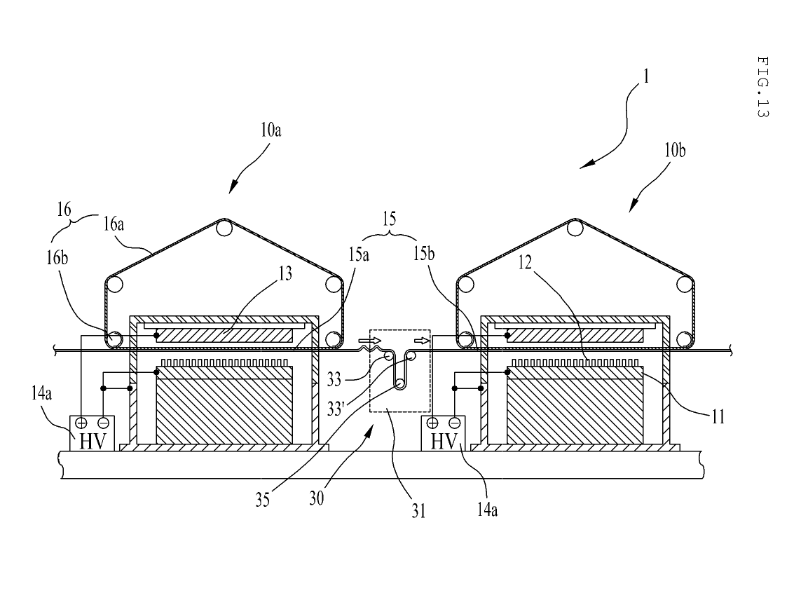

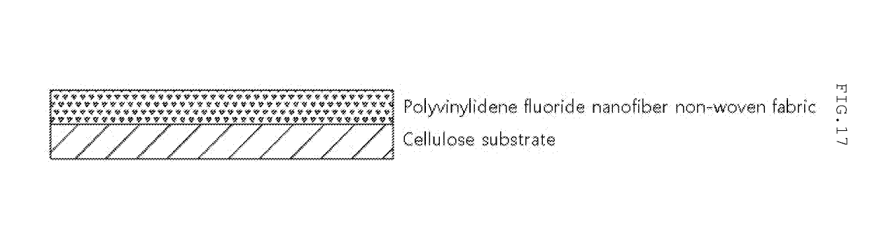

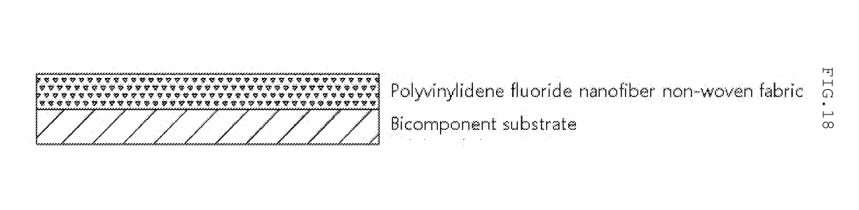

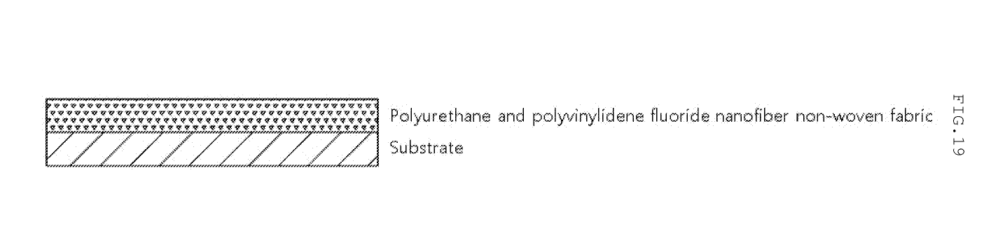

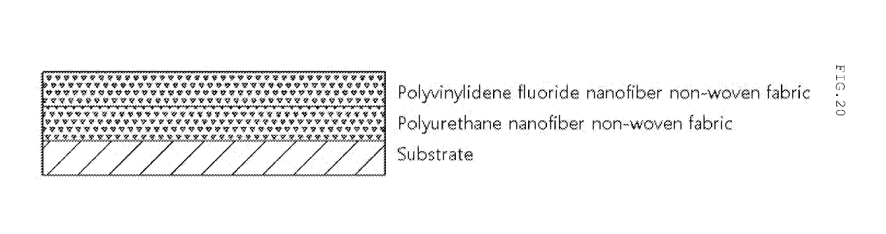

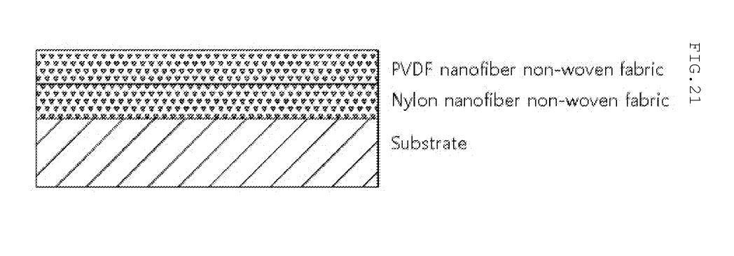

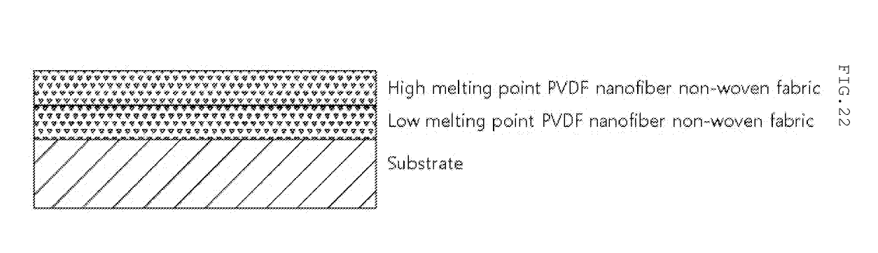

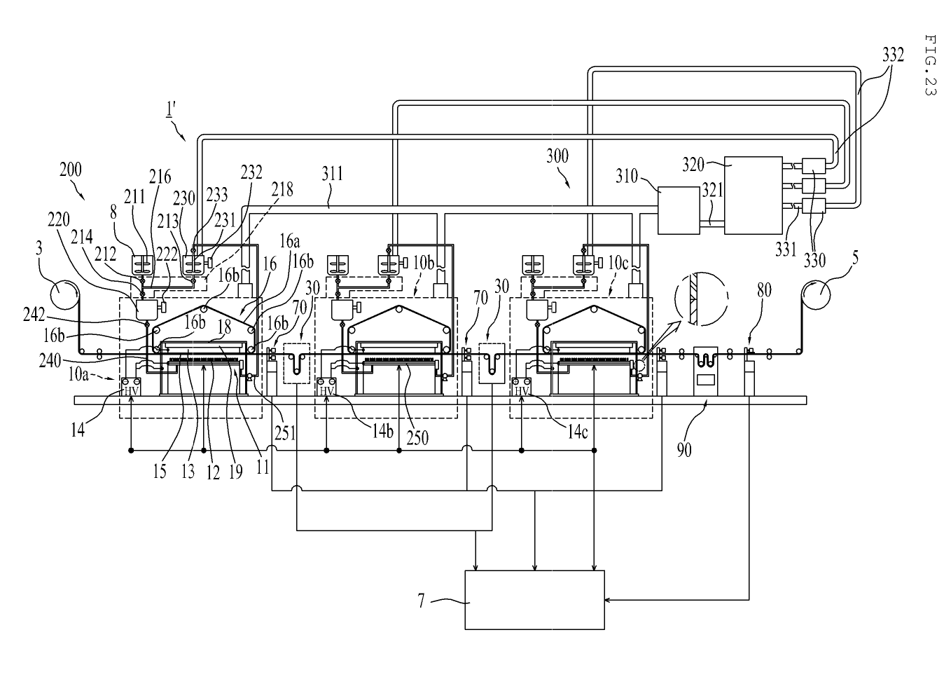

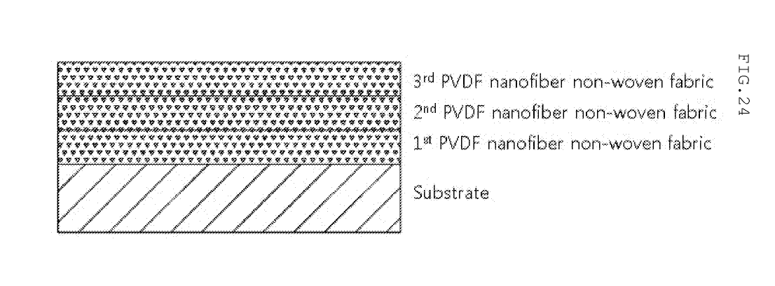

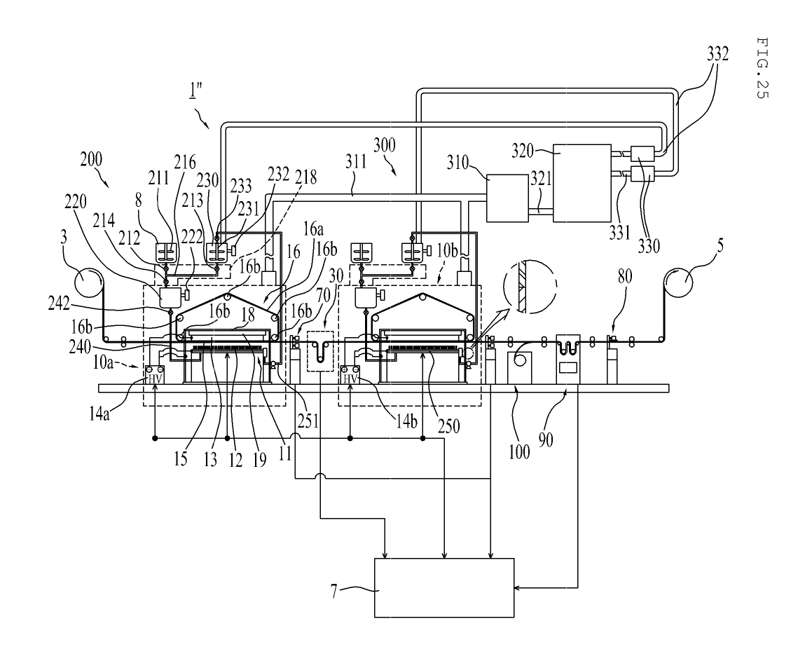

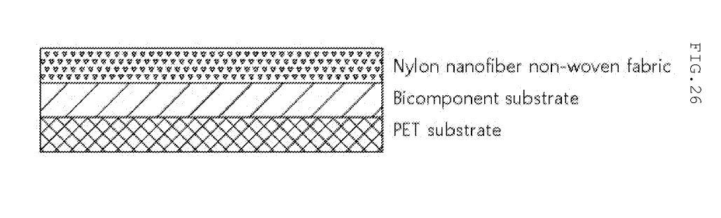

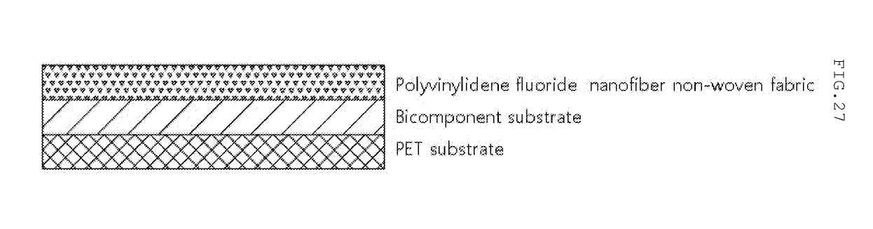

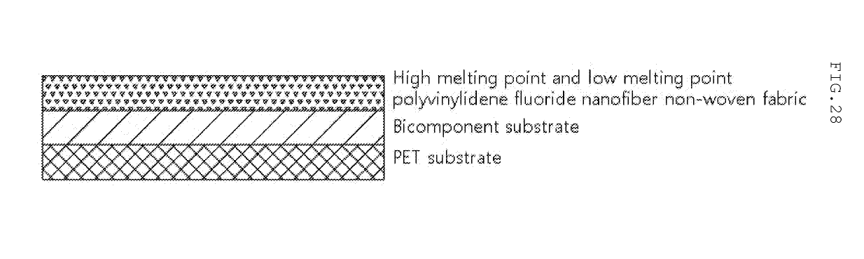

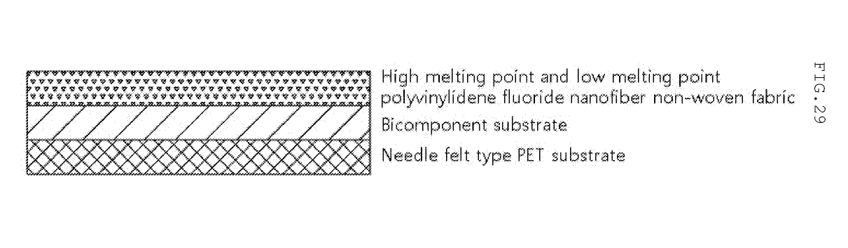

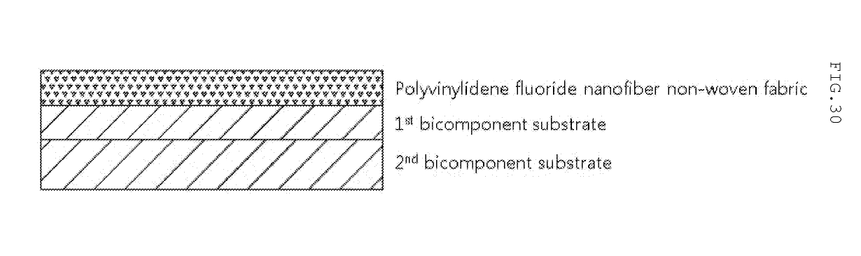

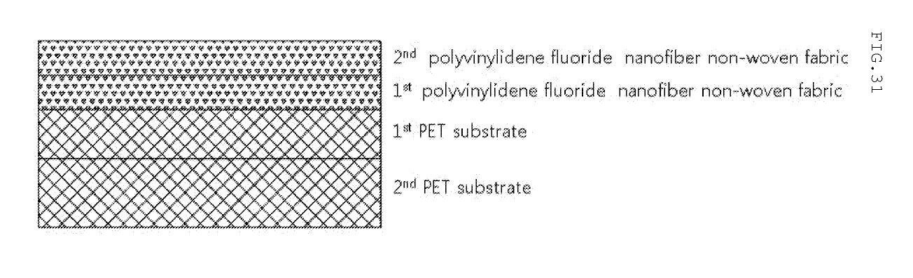

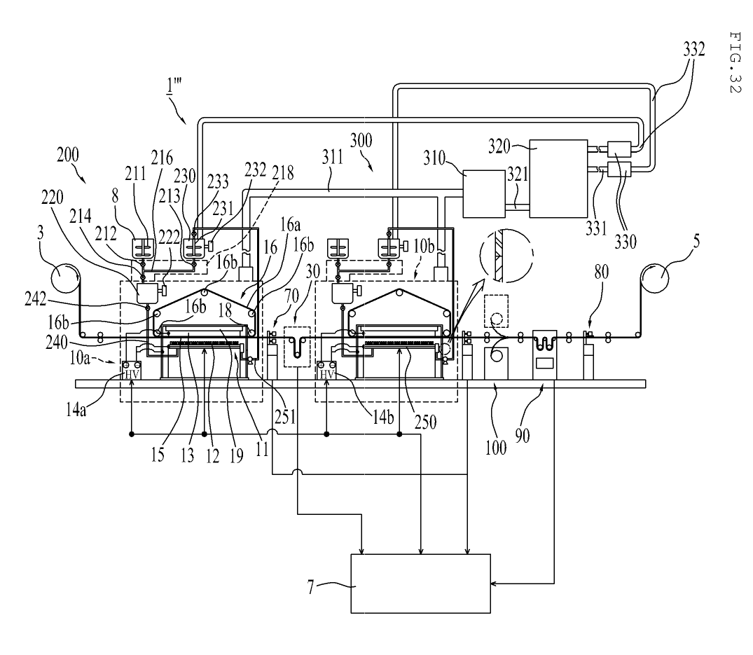

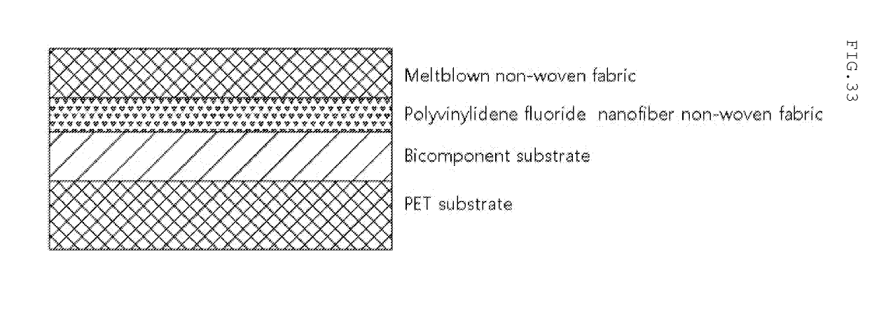

FIG. 1 schematically shows a side view of an electrospinning apparatus according to an exemplary embodiment of the present invention, FIG. 2 schematically illustrates a side view of nozzle of a nozzle block installed in each unit of the electrospinning apparatus according to an exemplary embodiment of the present invention, FIG. 3 schematically illustrates a side view of nozzle of a nozzle block installed in each unit of the electrospinning apparatus according to another exemplary embodiment of the present invention, FIG. 4 schematically depicts a top plan view of a nozzle block installed in each unit of the electrospinning apparatus according to an exemplary embodiment of the present invention, FIG. 5 schematically shows a front sectional view of heat transfer device in a nozzle block installed in each unit of the electrospinning apparatus according to an exemplary embodiment of the present invention, FIG. 6 is a cross-sectional view of A-A′ line according to an exemplary embodiment of the present invention, FIG. 7 schematically shows a front sectional view of heat transfer device in a nozzle block installed in each unit of the electrospinning apparatus according to another exemplary embodiment of the present invention, FIG. 8 shows a cross-sectional view of B-B′ line according to an exemplary embodiment of the present invention, FIG. 9 schematically shows a front sectional view of heat transfer device in a nozzle block installed in each unit of the electrospinning apparatus according to the other exemplary embodiment of the present invention, FIG. 10 shows a cross-sectional view of C-C′ line according to an exemplary embodiment of the present invention, FIG. 11 schematically illustrates a view of an auxiliary carry device of the electrospinning apparatus according to an exemplary embodiment of the present invention, FIG. 12 schematically illustrates a view of an auxiliary belt roller of an auxiliary carry device of the electrospinning apparatus according to another exemplary embodiment of the present invention, FIG. 13 to FIG. schematically illustrate a side view of operation process of an elongated sheet carry speed adjusting device of the electrospinning apparatus according to an exemplary embodiment of the present invention, FIG. 17 schematically shows a view of a filter comprising polyvinylidene fluoride nanofiber non-woven fabric on a cellulose substrate according to an exemplary embodiment of the present invention, FIG. 18 schematically shows a view of a filter comprising polyvinylidene fluoride nanofiber non-woven fabric on a bicomponent substrate according to an exemplary embodiment of the present invention, FIG. 19 schematically shows a view of a filter comprising polyurethane and polyvinylidene fluoride nanofiber non-woven fabric on a substrate according to an exemplary embodiment of the present invention, FIG. 20 schematically depicts a view of a filter comprising polyurethane nanofiber non-woven fabric and polyvinylidene fluoride nanofiber non-woven fabric on a substrate according to an exemplary embodiment of the present invention, FIG. 21 schematically depicts a view of a filter comprising nylon nanofiber non-woven fabric and polyvinylidene fluoride nanofiber non-woven fabric on a substrate according to an exemplary embodiment of the present invention, FIG. 22 schematically depicts a view of a filter comprising low melting point polyvinylidene fluoride nanofiber non-woven fabric and high melting point polyvinylidene fluoride nanofiber non-woven fabric on a substrate according to an exemplary embodiment of the present invention, FIG. 23 schematically illustrates a side view of an electrospinning apparatus according to an exemplary embodiment of the present invention, FIG. 24 schematically shows a view of a filter comprising a first, a second, a third polyvinylidene fluoride nanofiber non-woven fabric according to an exemplary embodiment of the present invention, FIG. 25 schematically illustrates a side view of an electrospinning apparatus according to another exemplary embodiment of the present invention, FIG. 26 schematically shows a view of a filter comprising nylon nanofiber non-woven fabric laminated on a bicomponent substrate which is laminated on a PET substrate according to an exemplary embodiment of the present invention, FIG. 27 schematically shows a view of a filter comprising polyvinylidene fluoride nanofiber non-woven fabric laminated on a bicomponent substrate which is laminated on a PET substrate according to an exemplary embodiment of the present invention, FIG. 28 schematically shows a view of a filter comprising high melting point and low melting point polyvinylidene fluoride nanofiber non-woven fabric laminated on a bicomponent substrate which is laminated on a PET substrate according to an exemplary embodiment of the present invention, FIG. 29 schematically shows a view of a filter comprising high melting point and low melting point polyvinylidene fluoride nanofiber non-woven fabric laminated on a bicomponent substrate which is laminated on a needle felt type PET substrate according to an exemplary embodiment of the present invention, FIG. 30 schematically shows a view of a filter comprising polyvinylidene fluoride nanofiber non-woven fabric laminated on a first bicomponent substrate which is laminated on a second bicomponent substrate according to an exemplary embodiment of the present invention, FIG. 31 schematically shows a view of a filter comprising a first and a second polyvinylidene fluoride nanofiber non-woven fabric laminated on a first PET substrate which is laminated on a second PET substrate according to an exemplary embodiment of the present invention, FIG. 32 schematically illustrates a side view of an electrospinning apparatus according to the other exemplary embodiment of the present invention, FIG. 33 schematically illustrates a view of a filter comprising polyvinylidene fluoride nanofiber non-woven fabric and meltblown non-woven fabric laminated on a bicomponent substrate which is laminated on a PET substrate according to an exemplary embodiment of the present invention.

As illustrated in the drawings, the electrospinning apparatus (1) according to the present invention comprises a bottom-up electrospinning apparatus (1), consecutively provided at least one or more units (10a, 10b) separated in predetermined space, each of the unit (10a, 10b) individually electrospinning the same polymer spinning solution, or individually electrospinning polymer spinning solution with different material, and produces filter material such as non-woven fabric.

For this, each of the unit (10a, 10b) comprises a spinning solution main tank (8) filling polymer spinning solution inside, a metering pump (not shown) for providing quantitatively polymer spinning solution filled in the spinning solution main tank (8), a nozzle block (11) installed a plurality of nozzle (12) comprising in pin form and discharging polymer spinning solution filled in the spinning solution main tank (8), a collector (13) separated in predetermined space from the nozzle (12) to collect polymer spinning solution jetted from the nozzle (12), and a voltage generator (14a, 14b) generating voltage to the collector (13).

The electrospinning apparatus (1) of the present invention according to the structure as stated above quantitatively provides polymer spinning solution filled in a spinning solution main tank (8) to a plurality of nozzle (12) formed in a nozzle block (11) through a metering pump, provided polymer spinning solution spun and line-focused on a collector (13) flowing high voltage through a nozzle (12), forms nanofiber non-woven fabric on an elongated sheet (15) moved from a collector (13), and formed nanofiber non-woven fabric produces filter or non-woven fabric.

Here, among each unit (10a, 10b) of the electrospinning apparatus (1), in a unit (10a) located in the front-end, provided a supply roller (3) for providing an elongated sheet (15) laminating formed nanofiber non-woven fabric by jetting of polymer spinning solution, and in a unit (10b) located in the rear-end, provided a winding roller (5) for winding an elongated sheet (15) laminating formed nanofiber non-woven fabric.

Meanwhile, an elongated sheet (15) going through each of the unit (10a, 10b) and laminating forming polymer spinning solution is properly comprising non-woven fabric or fabrics, and it does not limited thereto.

In this case, material of polymer spinning solution jetted through each unit (10a, 10b) is not limited, for example, polypropylene (PP), polyethylene terephthalate (PET), polyvinylidene fluoride, nylon, polyvinyl acetate, polymethyl methacrylate, polyacrylonitrile (PAN), polyurethane (PUR), polybutylene terephthalate (PBT), polyvinyl butyral, polyvinyl chloride, polyethyleneimine, polyolefin, polyactic acid (PLA), polyvinyl acetate (PVAc), polyethylene naphthalate (PEN), polyamide (PA), polyvinyl alcohol (PVA), polyethylene imide (PEI), polycaprolactone (PCL), polyacticacidglycidylrolsan (PLGA), silk, cellulose, chitosan, etc. Among them, polypropylene (PP) material and heat resistant polymer such as polyamide, polyimide, polyamideimide, poly(meta-phenylene isophthalamide), polysulfone, polyether ketone, polyether imide, aromatic polyester such as polyethylene terephthalate, polytrimethylene terephthalate, polyethylene naphthalate, polytetrafluoroethylene, polyphosphazene group such as polydiphenoxyphosphazene, poly bis[2-(2-methoxyethoxy)phosphazene], polyurethane and polyurethane copolymer such as polyesther polyurethane, and polymer such as cellulose acetate, cellulose acetate butyrate, and cellulose acetate propionate are preferably used in common.

Moreover, spinning solution provided through a nozzle (12) in the unit (10a, 10b) is solution dissolved polymer of synthetic resin material capable of electrospinning, the type of solvent is not limited if it is possible to dissolve polymer, for example, phenol, formic acid, sulfuric acid, m-cresol, T-fluorineaceticanhydride/dichloromethane, water, N-methylmorpholine, N-oxide, chloroform, tetrahydrofuran, and aliphatic ketone group such as methyl isobutylketone, methylelthylketone, and aliphatic hydroxyl group such as m-butyl alcohol, isobutyl alcohol, isopropyl alcohol, methyl alcohol, ethanol, and aliphatic compound group such as hexane, tetrachlorethylene, acetone, and glycol group such as propylene glycol, diethylene glycol, ethylene glycol, and halogen group such as trichloroethylene, dichloromethane, and aromatic compound group such as toluene, xylene, and alicyclic compound group such as cyclohexanon, cyclohexane, and ester group such as n-butyl acetate, ethyl acetate, and aliphatic ether group such as butylcellosalve, 2-ethoxyethanol acetate, 2-ethoxyethanol, and amide group such as dimethylformamide, dimethylacetamide, and a plurality of solvent can be mixed and used. In spinning solution, additives such as conductive improver are preferably contained.

Meanwhile, a nozzle (12) provided in a nozzle block (11) of the electrospinning apparatus (1) according to the present invention, as illustrated in FIG. 2, comprises a multi-tubular nozzle (500), and 2 or more inner and outer tubes (501, 502) have combined structure in Sheath-Core form capable of simultaneously electrospinning 2 or more polymer spinning solution.

Here, the nozzle block (11) comprises a nozzle plate (405) arranged multi-tubular nozzle (500) in Sheath-Core form, 2 or more spinning solution storage plates (407, 408) supplying polymer spinning solution (not shown) to a multi-tubular nozzle (500) and located in bottom of the nozzle plate (405), an overflow solution temporal storage plate (410) which is connected to a nozzle for overflow removal (415) wrapping a multi-tubular nozzle (500) and connected to the nozzle for overflow removal (415) and located in upper side of the overflow solution temporal storage plate, and a nozzle plate for overflow removal (416) located in upper side of the overflow solution temporal storage plate (410) and supporting a nozzle for overflow removal (415).

Also, further comprising a nozzle for air supply (404) wrapping the multi-tubular nozzle (500) and the nozzle for overflow removal (415), a nozzle support plate for air supply (414) located in the upper-most side of a nozzle block (11) and supporting a nozzle for air supply (404), an air inlet (413) located in lower side of a nozzle support plate for air supply (414) and supplying air to a nozzle for air supply (404), and an air storage plate (411) storing supplied air.

In addition, an overflow outlet (412) for discharging overflow solution to outside through the nozzle for overflow removal (415) is provided.

In an exemplary embodiment of the electrospinning apparatus (1) according to the present invention, the nozzle (12) comprises in cylinder form, as illustrated in FIG. 3, the nozzle (12) is cylinder of wedge form, and the front-end (503) forms in divergent shape in 5 to 30° angle to axis.

Here, the front-end (503) formed in the divergent shape is formed narrowing from top to bottom, and if it is formed narrowing from top to bottom, other various forms can be formed.

Meanwhile, the electrospinning apparatus (1) according to the present invention provided an overflow device (200). In other words, in each unit (10a, 10b) of the electrospinning apparatus (1) each provided an overflow device (200) comprising a spinning solution main tank (8), a second feed pipe (216), a second feed control device (218), a middle tank (220), and a recycled tank (230).

According to an embodiment of the present invention, in each unit (10a, 10b) of the electrospinning apparatus (1), each provided an overflow device (200), or among each of the unit (10a, 10b), one unit (10a) provided an overflow device (200), and in the overflow device (200), a unit (10b) located in the rear-end can comprise structure connected integrally.

According to the structure as stated above, the spinning solution main tank (8) stores spinning solution which is raw material of nanofiber. In the spinning solution main tank (8) provided an agitation device (211) for preventing spinning solution separation or solidification.

The second feed pipe (216) comprises a pipe connected to the spinning solution main tank (8) or a recycled tank (230) and a valve (212, 213, 214), and spinning solution is carried from the spinning solution main tank (8) or the recycled tank (230) to a middle tank (220).

The second feed control device (218) controls valve (212, 213, 214) of the second feed pipe (216), and controls carry motion of the second feed pipe (216). The valve (212) controls carrying of spinning solution from a spinning solution main tank (8) to a middle tank (220), and the valve (213) controls carrying of spinning solution from a recycled tank (230) to a middle tank (220). The valve (214) controls the amount of polymer spinning solution flowed from a spinning solution main tank (8) and a recycled tank (230) to a middle tank (220).

The control method as stated above is controlled according to the level of spinning solution measured by a second sensor (222) provided in the following middle tank (230).

The middle tank (220) stores spinning solution provided from a spinning solution main tank (8) or a recycled tank (230), provides the spinning solution to a nozzle block (11), and provided a second sensor (222) which measures level of provided pinning solution.

The second sensor (222) is properly a sensor which can measure level, such as a light sensor or an infrared sensor.

In bottom of the middle tank (220) provided a supply pipe (240) which supplies spinning solution to a nozzle block (11) and a supply control valve (242). The supply control valve (242) controls supply motion the supply pipe (240).

The recycled tank (230) sores spinning solution overflowed and retrieved, having an agitation device (231) for preventing separation and solidification of spinning solution, and having a first sensor (232) measuring level of retrieved spinning solution.

The first sensor (232) is properly a sensor which can measure level, such as a light sensor or an infrared sensor.

Meanwhile, spinning solution overflowed from a nozzle block (11) is retrieved through a spinning solution return path (250) provided in bottom of a nozzle block (11). The spinning solution return path (250) retrieves spinning solution through a first feed pipe (251) to a recycled tank (230).

Also, a first feed pipe (251) has a pipe connected to the recycled tank (230) and a pump, and by power of the pump, spinning solution is carried from a spinning solution return path (250) to a recycled tank (230).

In this case, the recycled tank (230) is properly at least one or more, and in the case of two or more, a plurality of the first sensor (232) and valve (233) can be provided.

Moreover, in the case of two or more recycled tank (230), as a plurality of valve (233) located in top of the recycled tank (230) is provided, a first feed control device (not shown) according to level of the first sensor (232) provided in the recycled tank (230) controls two or more valve (233) located in top, and controls whether to carry spinning solution to any one recycled tank (230) among a plurality of recycled tank (230).

Meanwhile, the electrospinning apparatus (1) has a VOC recycling device (300). In other words, in each unit (10a, 10b) of the electrospinning apparatus, the VOC recycling device (300) comprises a condensation device (310) for condensing and liquefying VOC(Volatile Organic Compounds) generated when spinning polymer spinning solution through a nozzle (12), a distillation device (320) distilling and liquefying condensed VOC through the condensation device (310), and a solvent storage device (330) storing liquefied solvent through the distillation device (320).

Here, the condensation device (310) is properly comprising water-cooled, evaporative, or air-cooled condensation device, but it does not limited thereto.

Meanwhile, pipes (311, 331) are each connected and installed to inflow VOC in evaporation state generated in each of the unit (10a, 10b) to a condensation device (310) and to store VOC in liquefaction state generated in the condensation device (310) to a solvent storage device (330).

In other words, pipes (311, 331) are each connected and installed to each of the unit (10a, 10b), to a condensation device (310) and to a solvent storage device (330).

According to an embodiment of the present invention, comprising structure of after condensing VOC through the condensation device (310) and providing condensed VOC in liquefaction state to a solvent storage device (330), or in the case of between the condensation device (310) and the solvent storage device (330) provided a distillation device (320) and one or more solvent is applied, each solvent can be comprised in separation and classification.

Here, the distillation device (320) is connected to a condensation device (310), heats VOC in liquefaction state in high temperature heat and evaporates it, again cooling it, and liquefied VOC is provided to a solvent storage device (330).

In this case, the VOC recycling device (300) comprises a condensation device (310) which provides air and cooling water to evaporated VOC discharged through each unit (10a, 10b) and condenses and liquefies, a distillation device (320) which heats VOC condensed through the condensation device (310), making it in evaporation state, again cooling it and making in liquefaction state, and a solvent storage device (330) storing VOC liquefied through the distillation device (320).

Here, the distillation device (320) is properly comprising as fractional distillation device, but it does not limited thereto.

In other words, pipes (311, 321, 331) for interconnecting each of the unit (10a, 10b) and a condensation device (310), the condensation device (310) and a distillation device (320), and the distillation device (320) and a solvent storage device (330) are each connected and installed.

In addition, measuring solvent content of spinning solution overflowed and retrieved in the recycled tank (230). The measurement extracts sample of some spinning solution among recycled tank (230), and analyzes the sample. Analysis of spinning solution can be held by method already known.

Based on the measurement result as stated above, required amount of solvent provides VOC in liquefaction state supplied to the solvent storage device (330) provides to the recycled tank (230) through a pipe (332). In other words, liquefied VOC is provided to the recycled tank (230) in required amount according to the measurement result, and can be reused and recycled as solvent.

Here, a case (18) comprising each unit (10a, 10b) of the electrospinning apparatus (1) is properly comprising an electric conductor, or the case (18) comprises an electric insulator, or the case (18) can be mixed an electric conductor and an electric insulator and applied, and other various materials can be comprised.

Moreover, in the case of top of the case (18) comprises an electric insulator and the bottom comprises an electric conductor, an insulation member (19) can be deleted. For this, the case (18) mutually combines the bottom forming an electric conductor and the top comprising an electric insulator and properly forms one case (18), but it does not limited thereto.

As stated above, the case (18) forms an electric conductor and an electric insulator, and top of the case (18) forms an electric insulator, in order to attach a collector (13) in upper inner side of case (18), separately provided insulation member (19) can be deleted, and because of this, composition of device can be streamlined.

Also, insulation between the collector (13) and the case (18) can be optimized, in the case of operating electrospinning by applying 35 kV between a nozzle block (11) and a collector (13), insulation breakdown generated between the collector (13) and the case (18) and other members can be prevented.

In addition, as leak voltage can be stopped in desired realm, surveillance in current provided from a voltage generator (14a, 14b) is possible, and error in the electrospinning apparatus (1) can be noticed early, so long time consecutive operation of the electrospinning apparatus (1) is possible, manufacture of nanofiber with required quality is stable, and mass-production of nanofiber is possible.

Here, thickness (a) of the case (18) forming as an electric insulator comprises satisfying “a=8 mm”.

Because of this, in the case of operating electrospinning by applying 40 kV between the nozzle block (11) and the collector (13), insulation breakdown generated between the collector (13) and the case (18) and other members can be prevented, and leak voltage can be limited in desired realm.

Also, in terms of distance between inner side of a case (18) formed electric insulator and outer side of a collector (13), the case (18) thickness (a) and distance (b) between inner side of the case (18) and outer side of the collector (13) satisfy “a+b=80 mm”.

Because of this, in the case of operating electrospinning by applying 40 kV between the nozzle block (11) and the collector (13), insulation breakdown generated between the collector (13) and the case (18) and other members can be prevented, and leak voltage can be limited in desired realm.

Meanwhile, in each pipe (40) of a nozzle block (11) installed in each unit (10a, 10b) of the electrospinning apparatus provided a temperature adjusting control device (60) and it is connected to a voltage generator (14a, 14b).

In other words, as illustrated in FIG. 4, installed in each of the unit (10a, 10b), in pipe (40) of nozzle block (11) comprising a plurality of nozzle (12) in the top and supplying polymer spinning solution is provided a temperature adjusting control device (60).

Here, polymer spinning solution in the nozzle block (11) is provided from a spinning solution main tank (8) which stored polymer spinning solution to each pipe (40) through solution flow pipe.

Moreover, polymer spinning solution provided to each of the pipe (40) is discharged and jetted through a plurality of nozzle (12) and collected to an elongated sheet (15) in nanofiber form.

In top of each pipe (40), in length direction, a plurality of nozzle (12) is separated in predetermined space and mounted, and the nozzle (12) and the pipe (40) comprises as an electric conductor member, electrically connected and mounted to the pipe (40)

Here, in order to control temperature adjustment of polymer spinning solution supplied and flowed in to each of the pipe (40), the temperature adjusting control device (60) comprises heat line (41, 42) provided in inner side of a pipe (40) or a pipe (43).

Also, in order to adjust temperature of the plurality of pipe (40), a temperature adjusting control device (60) is provided.

In this case, as illustrated in FIG. 5 to FIG. 6, the temperature adjusting control device (60) in heat line (41) form is formed in spiral shape in inner side of pipe (40) of the nozzle block (11), and is preferably comprising to adjust temperature of polymer spinning solution supplied and flowed in to the pipe (40).

In an exemplary embodiment of the present invention, in inner side of pipe (40) of the nozzle block (11), the temperature adjusting control device (60) is formed in heat line (41) form in spiral shape, as illustrated in FIG. 7 to FIG. 8, the temperature adjusting control device (60) in heat line (42) form can be provided in a plurality of number in inner side of the pipe (40), and as illustrated in FIG. 9 to FIG. 10, the temperature adjusting control device (60) in the pipe (43) form can be provided in approximately “C” form in inner side of the pipe (40).

Here, as illustrated in FIG. 11, an auxiliary carry device (16) for adjusting feed speed of an elongated sheet (15) incoming and providing in each unit (10a, 10b) of the electrospinning apparatus (1) is provided.

The auxiliary carry device (16) comprises an auxiliary belt (16a) which rotates and synchronizes feed speed of an elongated sheet (15) in order to facilitate desorption and carrying of an elongated sheet (15) attached by electrostatic gravitation to a collector (13) installed in each unit (10a, 10b), and an auxiliary belt roller (16b) supporting and rotating the auxiliary belt (16a).

According to the structure as mentioned above, an auxiliary belt (16a) rotates by rotation of the auxiliary belt roller (16b), an elongated sheet (15) incomes and supplies to units (10a, 10b) by rotation of the auxiliary belt (16a), for this, any one auxiliary belt roller (16b) among the auxiliary belt roller (16b) is connected to a motor capable of rotation.

According to an embodiment of the present invention, the auxiliary belt (16a) is provided 5 auxiliary belt rollers (16b), comprising by a motor motion, any one auxiliary belt roller (16b) rotates, as auxiliary belt (16a) rotates simultaneously the other auxiliary belt roller (16b) rotates, or the auxiliary belt (16a) is provided 2 or more auxiliary belt rollers (16b), comprising by a motor motion, any one auxiliary belt roller (16b) rotates, according to this, auxiliary belt (16a) and the other auxiliary belt roller (16b) rotate.

Meanwhile, in an embodiment of the present invention, the auxiliary carry device (16) comprises an auxiliary belt roller (16b) which is capable of driving by a motor and an auxiliary belt (16a), and as illustrated in FIG. 12, the auxiliary belt roller (16b) can comprise a roller with low coefficient of friction.

In this case, the auxiliary belt roller (16b) is preferably comprising of a roller including bearing with low coefficient of friction.

In an embodiment of the present invention, the auxiliary carry device (16) comprises an auxiliary belt (16a) and an auxiliary belt roller (16b) with low coefficient of friction, and the auxiliary belt (16a) can comprise providing a roller with low coefficient of friction and carrying an elongated sheet (15).

Also, in an embodiment of the present invention, for the auxiliary belt roller (16b), a roller with low coefficient of friction is applied, and if a roller has low coefficient of friction, the form and composition are not limited, and it is applied to a roller comprising bearings such as rolling bearing, oil bearing, ball bearing, roller bearing, sliding bearing, sleeve bearing, hydrodynamic journal bearing, hydrostatic bearing, pneumatic bearing, air dynamic bearing, air static bearing, and air bearing, and applied to a roller decreasing coefficient of friction by including materials such as plastic and emulsifier, and additives.

Meanwhile, the electrospinning apparatus (1) according to the present invention is provided a thickness measurement device (70). In other words, as illustrated in FIG. 1, between each unit (10a, 10b) of the electrospinning apparatus (1) is provided a thickness measurement device (70), and according to thickness measured by the thickness measurement device (70), feed speed (V) and a nozzle block (11) are controlled.

According to the structure as mentioned above, in the case of thickness of nanofiber non-woven fabric discharged from a unit (10a) located in the front-end of the electrospinning apparatus (1) is measured thinner than deviation, the next unit (10b) feed speed can be slowed, and discharging amount of nozzle block (11) is increased, by adjusting voltage intensity of a voltage generator (14a, 14b), increases discharging amount of nanofiber non-woven fabric per unit, and makes thicker thickness.

Also, in the case of thickness of nanofiber non-woven fabric discharged from a unit (10a) located in the front-end of the electrospinning apparatus (1) is measured thicker than deviation, the next unit (10b) feed speed (V) can be faster, discharging amount of nozzle block (11) is lessen, by adjusting voltage intensity of a voltage generator (14a, 14b), lessen discharging amount of nanofiber non-woven fabric per unit, lessen laminating amount, and making thinner thickness, and because of this, nanofiber non-woven fabric having uniformed thickness can be produced.

Here, the thickness measurement device (9) is arranged in up and down opposite sides put between an elongated sheet (15) which is capable of incoming and supplying, and provided a thickness measurement portion comprising a pair of ultrasonic wave, longitudinal wave, and transverse wave measuring method that measures the distance to top or bottom of the elongated sheet (15) by ultrasonic wave measuring method.

Based on the distance measured by the pair of ultrasonic wave measuring device, thickness of the elongated sheet (15) can be calculated. In other words, the thickness measurement device projects ultrasonic wave, longitudinal wave, and transverse wave to an elongated sheet (15) laminated nanofiber non-woven fabric, each ultrasonic signal of longitudinal wave and transverse wave measures reciprocating movement time from an elongated sheet (15), in other words, after measuring propagation time of each longitudinal wave and transverse wave, and using ultrasonic wave, longitudinal wave, and transverse wave and measuring the thickness from a desired formula using the measured propagation time of longitudinal wave and transverse wave, propagation speed of longitudinal wave and transverse wave from reference temperature of an elongated sheet (15) laminated nanofiber non-woven fabric, and constant of temperature of propagation speed of longitudinal wave and transverse wave.

In other words, the thickness measurement device (70) measures each propagation time of ultrasonic wave, longitudinal wave, and transverse wave, and by calculating thickness of an elongated sheet (15) laminated nanofiber non-woven fabric from a desired formula using propagation time of the measured longitudinal wave and transverse wave, propagation velocity of longitudinal wave and transverse wave from reference temperature of an elongated sheet (15), and constant of temperature of propagation speed of longitudinal wave and transverse wave, even in state of inner temperature is non-uniform, it can precisely measure thickness by compensating error occurred by change in propagation speed according to temperature change, and can precisely measure thickness in any kind of temperature distribution inside nanofiber non-woven fabric.

Meanwhile, the electrospinning apparatus (1) of the present invention is provided a thickness measurement device (70) which measures thickness of nanofiber non-woven fabric of an elongated sheet (15) carried after polymer spinning solution is sprayed and laminated, and controls an elongated sheet (15) feed speed and a nozzle block (11). Also, the electrospinning apparatus (1) is provided an elongated sheet carry speed adjusting device (30) for adjusting feed speed of an elongated sheet (15).

Here, the elongated sheet carry speed adjusting device (30) comprises a buffer section (31) forming between each unit (10a, 10b) of the electrospinning apparatus (1), a pair of support roller (33, 33′) provided on the buffer section (31) and supporting an elongated sheet (15), and an adjusting roller (35) provided between the pair of support roller (33, 33′).

In this case, the support roller (33, 33′) is for supporting the elongated sheet (15) carry when conveying of an elongated sheet (15) laminating formed nanofiber non-woven fabric by spinning solution jetted by a nozzle (12) in each of the unit (10a, 10b), and the support roller (33, 33′) is each provided in the front-end and the rear-end of a buffer section (31) formed between each of the unit (10a, 10b).

In addition, the adjusting roller (35) is provided between the pair of support roller (33, 33′), the elongated sheet (15) is wound, and by up and down motion of the adjusting roller (35), feed speed and movement time of an elongated sheet (15a, 15b) are adjusted according to each of the unit (10a, 10b).

For this, a sensing sensor (not shown) for sensing feed speed of an elongated sheet (15a, 15b) in each of the unit (10a, 10b) is provided, and a main control device (7) for controlling an adjusting roller (35) motion according to feed speed of an elongated sheet (15a, 15b) in each unit (10a, 10b) sensed by the sensing sensor is provided.

In an embodiment of the present invention, in each of the unit (10a, 10b), an elongated sheet (15a, 15b) feed speed is sensed, according to the sensed elongated sheet (15a, 15b) feed speed, a controlling portion controls an adjusting roller (35) motion, or sensing an auxiliary belt (16a) for conveying the elongated sheet (15a, 15b) and provided in the outer side of a collector (13) or an auxiliary belt roller (16b) for driving the auxiliary belt (16a) or a motor (not shown) driving speed, and according to this, a controlling portion controls an adjusting roller motion.

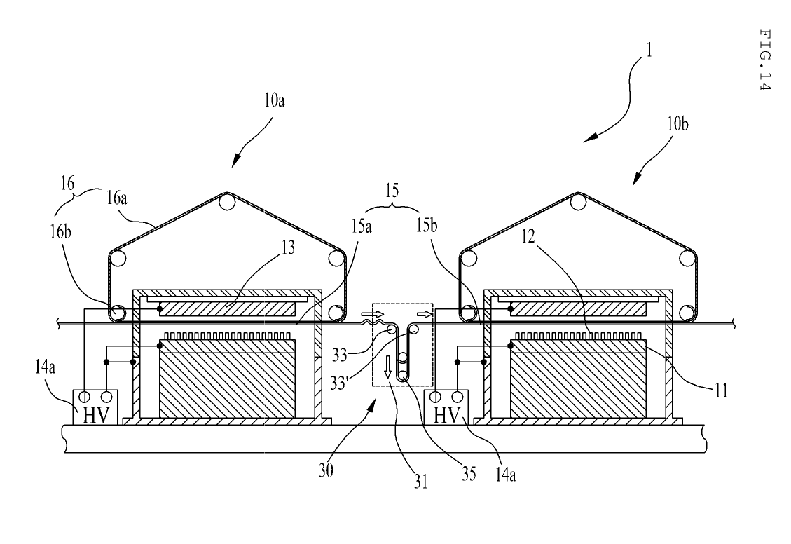

According to the structure described above, in the case of the sensing sensor sensed feed speed of an elongated sheet (15a) in a unit (10a) located in the front-end among each unit (10a, 10b) is faster than feed speed of an elongated sheet (15b) in unit (10b) located in the rear-end, as illustrated in FIG. 13 to FIG. 14, in order to prevent sagging of an elongated sheet (15a) carried from a unit (10a) located in the front-end, provided between the pair of support roller (33, 33′), an elongated sheet (15) moves wound adjusting roller (35) to lower side, among an elongated sheet (15) carried from a unit (10a) located in the front-end to a unit (10b) located in the rear-end, pulling an elongated sheet (15a) carried to the external side of a unit (10a) located in the front-end and excessively carried to a buffer section (31) located between each unit (10a, 10b), and correct and control to make feed speed of an elongated sheet (15a) in a unit (10a) located in the front-end and feed speed of an elongated sheet (15b) in unit (10b) located in the rear-end same, and prevents sagging and crumpling of an elongated sheet (15a).

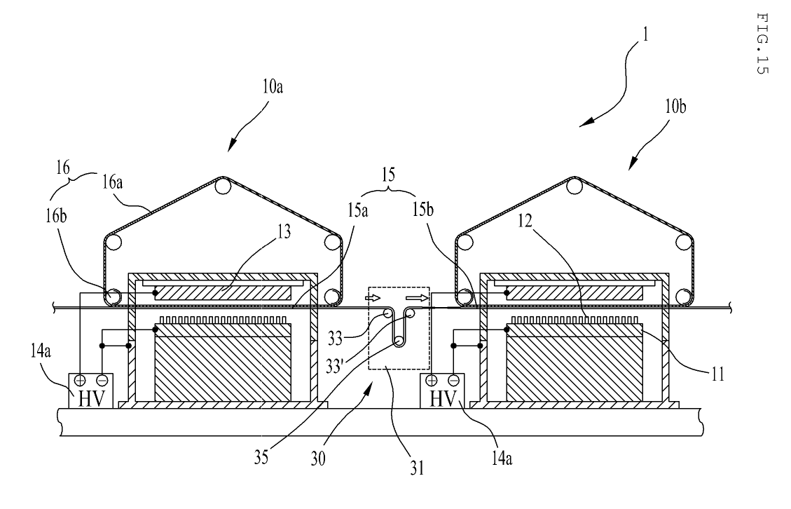

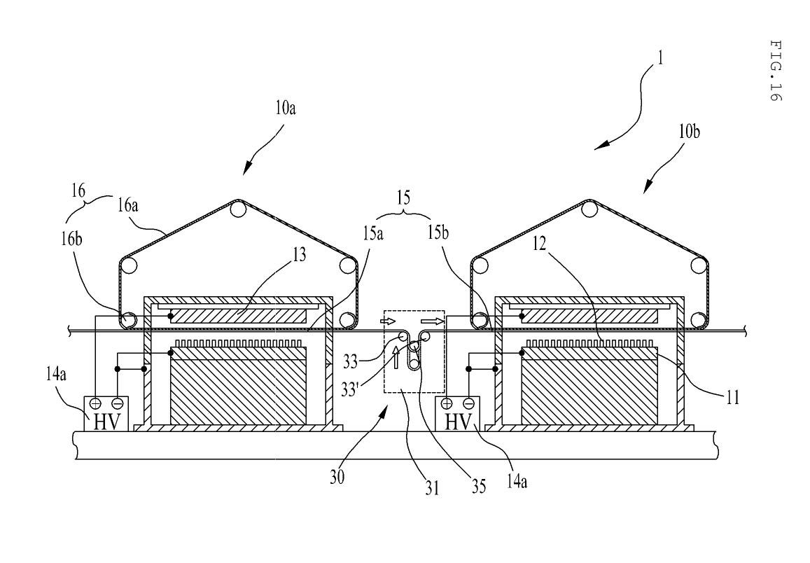

Meanwhile, in the case of the sensing sensor sensed feed speed of an elongated sheet (15a) in a unit (10a) located in the front-end among each unit (10a, 10b) is slower than feed speed of an elongated sheet (15b) in unit (10b) located in the rear-end, as illustrated in FIG. 15 to FIG. 16, in order to prevent snapping of an elongated sheet (15b) carried from a unit (10b) located in the rear-end, provided between the pair of support roller (33, 33′), an elongated sheet (15) moves wound adjusting roller (35) to upper side, among an elongated sheet (15) carried from a unit (10a) located in the front-end to a unit (10b) located in the rear-end, an elongated sheet (15a) carried to the external side of a unit (10a) located in the front-end and wound by an adjusting roller (35) in a buffer section (31) located between each unit (10a, 10b) is quickly provided to a unit (10b) in the rear-end, and correct and control to make feed speed of an elongated sheet (15a) in a unit (10a) located in the front-end and feed speed of an elongated sheet (15b) in unit (10b) located in the rear-end same, and prevents snapping of an elongated sheet (15a).

According to the structure as described above, by adjusting feed speed of an elongated sheet (15b) carried to a unit (10b) located in the rear-end among each of the unit (10a, 10b), it can achieve effects such as feed speed of an elongated sheet (15b) in a unit (10b) located in the rear-end among each of the unit (10a, 10b) and feed speed of an elongated sheet (15a) in a unit (10a) located in the front-end are same.

Meanwhile, the electrospinning apparatus (1) of the present invention is provided a permeability measuring device (80). In other words, a permeability measuring device (80) for measuring permeability of nanofiber non-woven fabric produced through the electrospinning apparatus (1) in the rear of a unit (10b) located in the rear-end among each unit (10a, 10b) is provided.

As described above, based on the permeability of nanofiber non-woven fabric measured through the permeability measuring device (80), an elongated sheet (15) feed speed and a nozzle block (11) are controlled.

In the case of permeability of nanofiber non-woven fabric discharged through each unit (10a, 10b) of the electrospinning apparatus (1) is measured large, by slowing feed speed (V) of a unit (10b) located in the rear-end, by increasing discharging amount of a nozzle block (11), and by increasing discharging amount of nanofiber per unit area by adjusting voltage intensity of a voltage generator (14a, 14b), forms permeability small.

Also, in the case of the permeability of nanofiber non-woven fabric discharged through each unit (10a, 10b) of the electrospinning apparatus (1) is measured small, by increasing feed speed (V) of a unit (10b) located in the rear-end, by increasing discharging amount of a nozzle block (11), and by decreasing discharging amount of nanofiber per unit area by adjusting voltage intensity of a voltage generator (14a, 14b), forms permeability large.

As described above, after measuring permeability of the nanofiber non-woven fabric, by controlling each unit (10a, 10b) feed speed and a nozzle block (11) according to permeability, nanofiber non-woven fabric having uniformed permeability can be produced.

Here, in the case of permeability deviation (P) of the nanofiber non-woven fabric is less than a desired value, feed speed (V) is not changed from the initial value, and in the case of the permeability (P) is a desired value or more, as feed speed can be controlled to change from the initial value, control of feed speed (V) according to feed speed control device is possible.

Also, except for feed speed (V) control, a nozzle block (11) discharging amount and voltage intensity can be adjusted, in the case of permeability deviation (P) is less than a desired value, a nozzle block (11) discharging amount and voltage intensity are not changed from the initial value, and in the case of the deviation (P) is a desired value or more, a nozzle block (11) discharging amount and voltage intensity are controlled to change from the initial value, and control of nozzle block (11) discharging amount and voltage intensity can be simplified.

Here, the electrospinning apparatus (1) comprises a main control device (7), and the main control device (7) controls a nozzle block (11), a voltage generator (14a, 14b), a thickness measurement device (70), an elongated sheet carry speed adjusting device (30), and a permeability measuring device (80).

Meanwhile, a laminating device (90) for laminating nanofiber non-woven fabric electrospun through each unit (10a, 10b) of the electrospinning apparatus (1) is provided in the rear of a unit (10b) located in the rear-end among each of the unit (10a, 10b), and according to the laminating device (90), the post-process of nanofiber non-woven fabric electrospun through the electrospinning apparatus (1) is performed.

The following description explains manufacturing method of filter comprising nanofiber of the electrospinning apparatus according to the present invention.

In the present invention, for polymer uses polyvinylidene fluoride, and for an elongated sheet (15) uses a cellulose substrate. The cellulose substrate used in the present invention is excellent in dimensional stability in high temperature and has high heat-resisting property. In terms of cellulose fiber forming fine porous structure, it has high crystalline and high elasticity, and essentially it is fiber very excellent in dimensional stability. A cellulose substrate according to such features is used in consumer products such as highly efficient filter, functional paper, sheet for cooking, and intake sheet, etc. and technical fields such as semiconductor device, board for circuit board, substrate of low coefficient of thermal expansion material, and separator for power storage device.

The cellulose substrate used in the present invention preferably comprises composition rate of 100% cellulose, and a cellulose substrate comprising cellulose and polyethylene terephthalate in ratio of 70˜90:10˜30 weight % can be used, and a cellulose substrate of flame resistant coating can be used.

First, polyvinylidene fluoride solution which dissolved polyvinylidene fluoride in organic solvent is supplied to a spinning solution main tank (8) connected to each unit (10a, 10b) of the electrospinning apparatus, and polyvinylidene fluoride solution provided to the spinning solution main tank (8) is consecutively and quantitatively provided to a plurality of nozzle (12) of a nozzle block (11) provided high voltage through a metering pump (not shown). Polyvinylidene fluoride solution provided from each of the nozzle (12) is electrospun and line-focused through a nozzle (12) on a cellulose substrate located on a collector (13) provided high voltage, and laminating forming polyvinylidene fluoride nanofiber non-woven fabric.

Meanwhile, in each unit (10a, 10b) of the electrospinning apparatus (1), a substrate laminated polyvinylidene fluoride nanofiber non-woven fabric is carried from the first unit (10a) to the second unit (10b) by a supply roller (3) operated by driving of a motor (not shown) and an auxiliary carry device (16) driving by rotation of the supply roller (3), the process is repeated, and on the substrate, nanofiber non-woven fabric is consecutively electrospun and laminating formed.

According to the present invention, spinning solution provided to the spinning solution main tank (8) used polyvinylidene fluoride solution which dissolved polyvinylidene fluoride in organic solvent, or polyvinylidene fluoride and hot-melt can be mixed and used, or polyvinylidene fluoride solution and hot-melt solution can be provided differently according to each unit. Here, the hot-melt uses polyvinylidene fluoride group hot-melt, and it plays a role as adhesive on polyvinylidene fluoride nanofiber non-woven fabric and a cellulose substrate, and prevents separation of the polyvinylidene fluoride nanofiber non-woven fabric from a cellulose substrate.

Also, in the process of electrospinning and laminating forming the polyvinylidene fluoride solution on the cellulose substrate, by differing spinning conditions according to each unit (10a, 10b) of the electrospinning apparatus, in a first unit (10a), laminating forming polyvinylidene fluoride nanofiber non-woven fabric with large fiber diameter, and in a second unit (10b), consecutively laminating forming polyvinylidene fluoride nanofiber non-woven fabric with small fiber diameter.

In this case, a voltage generator (14a) installed in a first unit (10a) of the electrospinning apparatus (1) and providing voltage to a first unit (10a) is provided low spinning voltage, and forms polyvinylidene fluoride nanofiber non-woven fabric of fiber diameter of 150 to 300 nm on a cellulose substrate, and a voltage generator (14b) installed in a second unit (10b) and providing voltage to a second unit (10b) is provided high spinning voltage, laminating forming polyvinylidene fluoride nanofiber non-woven fabric of fiber diameter of 100 to 150 nm on the polyvinylidene fluoride nanofiber non-woven fabric of fiber diameter of 150 to 300 nm. Here spinning voltage provided by each of the voltage generator (14a, 14b) is 1 kV or more, and preferably 15 kV or more, and voltage provided by a voltage generator (14a) of a first unit (10a) is lower than voltage provided by a voltage generator (14b) of a second unit (10b).

In an embodiment of the present invention, voltage of a first unit (10a) of the electrospinning apparatus (1) is provided low, laminating polyvinylidene fluoride nanofiber non-woven fabric of fiber diameter of 150 to 300 nm on a cellulose substrate, and voltage of a second unit (10b) is provided high, laminating forming polyvinylidene fluoride nanofiber non-woven fabric of fiber diameter of 100 to 150 nm, and produces a filter. However, by differing voltage intensity, polyvinylidene fluoride nanofiber non-woven fabric of fiber diameter of 100 to 150 nm spun and laminating formed in the first unit (10a), and polyvinylidene fluoride nanofiber non-woven fabric of fiber diameter of 150 to 300 nm can be spun in the second unit (10b).

Here, in order to put difference in fiber diameter, a method of differing voltage intensity provided according to each unit (10a, 10b) is used, or by adjusting the distance between a nozzle (12) and a collector (13), polyvinylidene fluoride nanofiber non-woven fabric with different fiber diameter can be formed. In the case of spinning solution type and provided voltage intensity is the same, according to the principle of the nearer spinning distance is, the larger fiber diameter is, and the further spinning distance is, the smaller fiber diameter is, 2 different nanofiber non-woven fabric can be formed. Also, by adjusting density and viscosity of spinning solution, or by adjusting moving speed of an elongated sheet, fiber diameter can be different.

In addition, by comprising 3 or more units of the electrospinning apparatus (1) and by differing electrospinning conditions according to each unit, a filter laminating formed layer or more polyvinylidene fluoride nanofiber non-woven fabric with different fiber diameter on a cellulose substrate can be produced.

According to the method as described above, consecutively laminating forming polyvinylidene fluoride nanofiber non-woven fabric on a cellulose substrate and thermosetting in a laminating device (90), and produces a filter according to the present invention.

### EXAMPLE 1

Polyvinylidene fluoride with weight average molecular weight of 50,000 is dissolved in N,N-Dimethylacetamide (DMAc) and produces spinning solution, and it is inserted in a spinning solution main tank of each unit of the electrospinning apparatus. In each unit, on a cellulose substrate, the spinning solution is consecutively electrospinning in conditions of the distance between an electrode and a collector is 40 cm, applied voltage 20 kV, spinning solution flow rate is 0.1 mL/h, temperature 22° C., and humidity 20%, and laminating formed polyvinylidene fluoride nanofiber non-woven fabric with thickness of 3 μm. After electrospinning, going through a process of thermosetting, and produces a filter.

### EXAMPLE 2

Polyvinylidene fluoride with weight average molecular weight of 50,000 is dissolved in N,N-Dimethylacetamide (DMAc) and produces spinning solution, and it is inserted in a spinning solution main tank of each unit of the electrospinning apparatus. In a first unit of the electrospinning apparatus, applied voltage is provided 15 kV, on a cellulose substrate, electrospinning the spinning solution, and laminating formed polyvinylidene fluoride nanofiber non-woven fabric with thickness of 2.5 μm and fiber diameter of 250 nm. In a second unit, applied voltage is provided 20 kV, electrospinning the spinning solution on the polyvinylidene fluoride nanofiber non-woven fabric, and laminating formed polyvinylidene fluoride nanofiber non-woven fabric with thickness of 2.5 μm and fiber diameter of 130 nm. In this case, in conditions of spinning solution flow rate is 0.1 mL/h, temperature 22° C., and humidity 20%, after electrospinning and going through thermosetting, and a filter is produced.

### EXAMPLE 3

Polyvinylidene fluoride resin for hot-melt with number average molecular weight of 3,000 is dissolved in N,N-Dimethylformamide (DMF) of 8 weight % and produces hot-melt solution, and it is inserted in a spinning solution main tank of a first of the electrospinning apparatus. Polyvinylidene fluoride with weight average molecular weight of 50,000 is dissolved in N,N-Dimethylacetamide (DMAc) and produces polyvinylidene fluoride spinning solution, and it is inserted in a spinning solution main tank of a second unit of the electrospinning apparatus. In the first unit of the electrospinning apparatus, on a cellulose substrate comprising composition rate of cellulose and PET is 80 weight %: 20 weight %, hot-melt solution is electrospun, and laminating formed hot-melt electrospinning layer of thickness of 1 μm, and in a second unit, laminating formed polyvinylidene fluoride nanofiber non-woven fabric of thickness of 3 μm on the hot-melt electrospinning layer. The electrospinning conditions and post process is the same as example 1.

### EXAMPLE 4

Polyvinylidene fluoride with weight average molecular weight of 50,000 and polyvinylidene fluoride resin for hot-melt with number average molecular weight of 3,000 is dissolved in N,N-Dimethylacetamide (DMAc) and produces spinning solution, and it is inserted to a spinning solution main tank of each unit of the electrospinning apparatus. In each unit, on a water-proof coating cellulose substrate, electrospinning the spinning solution in conditions of distance between an electrode and a collector is 40 cm, applied voltage 20 kV, spinning solution flow rate is 0.1 mL/h, temperature 22° C., and humidity 20%, and laminating forming polyvinylidene fluoride nanofiber non-woven fabric of thickness of 3 μm. After electrospinning, going through a process of thermosetting, and produces a filter.

### EXAMPLE 5

Polyvinylidene fluoride with weight average molecular weight of 50,000 and polyvinylidene fluoride resin for hot-melt with number average molecular weight of 3,000 is dissolved in N,N-Dimethylacetamide (DMAc) and produces spinning solution which mixed polyvinylidene fluoride and hot-melt, and it is inserted to a spinning solution main tank of a first unit of the electrospinning apparatus. Also, polyvinylidene fluoride solution which dissolved polyvinylidene fluoride in N,N-Dimethylacetamide is inserted to a spinning solution main tank of a second unit of the electrospinning apparatus. In the first unit, on a cellulose substrate, electrospinning spinning solution which mixed polyvinylidene fluoride and hot-melt, and laminating formed polyvinylidene fluoride-hot-melt nanofiber non-woven fabric with thickness of 2.5 μm. In the second unit, consecutively electrospinning the polyvinylidene fluoride spinning solution on the polyvinylidene fluoride-hot-melt nanofiber non-woven fabric, and laminating formed polyvinylidene fluoride nanofiber non-woven fabric with thickness of 2.5 μm. Electrospinning conditions and post process are the same as example 1.

### COMPARATIVE EXAMPLE 1

The cellulose substrate used in example 1 is used as filter medium.

### COMPARATIVE EXAMPLE 2

A filter is produced by laminating forming polyamide nanofiber non-woven fabric which electrospun polyamide on a cellulose substrate.

Filtering Efficiency Measurement

In order to measure efficiency of the produced nanofiber filter, DOP test method is used. DOP test method measures dioctylphthalate (DOP) efficiency by an automated filter analyzer (AFT) of TSI 3160 in TSI Incorporated, and it can measure a filter media material permeability, filter efficiency, and pressure difference.

The automated analyzer makes DOP in a desired size particle, penetrates on a filter sheet, and automatically measures air speed, DOP filtering efficiency, air permeability in coefficient method, and it is very important device in high efficiency filter.
DOP % efficiency is defined as follows.
DOP % transmissivity=1-100 (lower DOP concentration/upper DOP concentration)

Filtering efficiency in example 1 to 5 and comparative example 1 is measured by the method as described above, and it is shown in Table 1.

TABLE 1

| | Exam- | Exam- | Exam- | Exam- | Exam- | Comparative |
|---|---|---|---|---|---|---|
| | ple 1 | ple 2 | ple 3 | ple 4 | ple 5 | Example 1 |
| 0.35 μm | 90 | 93 | 92 | 92 | 93 | 70 |
| DOP | | | | | | |
| Filtering | | | | | | |
| efficiency | | | | | | |
| (%) | | | | | | |

As described above, a filter produced in example 1 to 5 of the present invention is excellent in filtering efficiency compared to comparative example 1.

Pressure Drop and Filter Sustainability Measurement

The produced nanofiber non-woven fabric filter is measured pressure drop by ASHRAE 52.1 according to flow rate of 50/m³, and measures filter life according to this. Table 2 shows data comparing example 1 to 5 and comparative example 1.

TABLE 2

| | Exam- | Exam- | Exam- | Exam- | | Comparative |
|---|---|---|---|---|---|---|
| | ple 1 | ple 2 | ple 3 | ple 4 | Example 5 | example 1 |
| Pressure | 4.5 | 4.3 | 4.2 | 4.5 | 4.2 | 8 |
| drop | | | | | | |
| (in.w.g) | | | | | | |
| Filter | 6.4 | 6.5 | 6.5 | 6.4 | 6.5 | 4 |
| life | | | | | | |
| (month) | | | | | | |

According to Table 2, a filter produced through an embodiment of the present invention, compared to comparative example, has low pressure drop which results in low pressure lose and has longer filter life which results in excellence in durability.

Desorption of Nanofiber Non-Woven Fabric

In result of measuring whether desorption or not of nanofiber non-woven fabric and a filter substrate of the produced filter by ASTM D 2724 method, in a filter produced by example 3, 4 and 5 does not occur desorption of nanofiber non-woven fabric, and a filter produced by comparative example 2 occurs desorption of nanofiber non-woven fabric.

Therefore, a filter produced through an embodiment of the present invention, compared to comparative example, does not occur desorption well between nanofiber non-woven fabric and a substrate.

Meanwhile, in an embodiment of the present invention, for substrate of a filter, a cellulose substrate is used, or a bicomponent substrate can be used.

In an embodiment of the present invention, for polymer spinning solution, polyvinylidene fluoride solution is used, and for an elongated sheet (15), a bicomponent substrate is used. Fiber forming polymer of a bicomponent substrate used in an embodiment can be polyester comprising polyethylene terephthalate, polyethylene naphthalate, polypropylene terephthalate, and polybutylene terephthalate, and polypropylene terephthalate also is polybutylene terephthalte such as polytrimethylene terephthalte and polytetramethylene terephthalte.

A bicomponent substrate of an embodiment of the present invention is most preferably polyethylene terephthalate combined two components of different melting point. The polyethylene terephthalate bicomponent substrate can be classified as Sheath-Core, Side-by-Side, and C-Type. Among them, in the case of Sheath-Core type bicomponent substrate, Sheath part is low melting point polyethylene terephthalate, and core part comprises generally polyethylene terephthalte. Here, the sheath part is approximately 10 to 90 weight %, and the core part comprises approximately 90 to 10 weight %. The sheath part acts as thermal bonding agent forming the outer surface of binder fiber, having a melting point of approximately 80 to 150° C., and the core part having a melting point of approximately 160 to 250° C. A Sheath-Core type bicomponent substrate used in an embodiment of the present invention, in the sheath part for a conventional melting point analyzer, comprising non-crystalline polyester copolymer not showing a melting point, and for the core part, it is preferably heat-adhesive composite fiber using relatively high melting point component.

Polyester copolymer included in sheath part is copolymer polyester made of polyethylene terephthalte unit in 50 to 70 mol %. Isophthalic acid is preferably for copolymer acid component in 30 to 50 mol %, but conventional dicarboxylic acid is all possible.

For a high melting point component used in core part, polymer with a melting point of 160° C. or more is preferable, for example, polyethylene terephthalate, polybutylene terephthalate, polyamide, polyethylene terephthalate copolymer, and polypropylene. Basis weight of the bicomponent used in an embodiment of the present invention is preferably 10 to 50 g/m².

Meanwhile, in order to produce a filter of an embodiment of the present invention, it is produced according to the manufacturing method as described above, for a substrate, a bicomponent is applied, and on the bicomponent substrate, polyvinylidene fluoride is electrospun, and forming nanofiber non-woven fabric, and produces a filter.

After laminating forming polyvinylidene fluoride nanofiber non-woven fabric in each unit (10a, 10b) according to the method as described above, going through a process of thermosetting in a laminating device (90), and produces a filter.

### EXAMPLE 6

Polyvinylidene fluoride with weight average molecular weight of 50,000 is dissolved in N,N-Dimethylacetamide (DMAc) and produces spinning solution, and it is inserted to a spinning solution main tank of each unit of the electrospinning apparatus. In each unit, on a bicomponent substrate, the spinning solution is electrospinning in conditions of distance between an electrode and a collector is 40 cm, applied voltage 20 kV, spinning solution flow rate is 0.1 mL/h, temperature 22° C., and humidity 20%, and laminating formed polyvinylidene fluoride nanofiber non-woven fabric with thickness of 3 μm. After electrospinning, going through a process of thermosetting in a laminating device, and produces a filter.

### EXAMPLE 7

Polyvinylidene fluoride with weight average molecular weight of 50,000 is dissolved in N,N-Dimethylacetamide (DMAc) and produces spinning solution, and it is inserted to a spinning solution main tank of each unit of the electrospinning apparatus. In a first unit of the electrospinning apparatus, applied voltage is provided 15 kV, on a bicomponent substrate, electrospinning the spinning solution, and laminating formed a first polyvinylidene fluoride nanofiber non-woven fabric with thickness of 2.5 μm and fiber diameter of 250 nm. In a second unit, applied voltage is provided 20 kV, electrospinning the spinning solution on the first polyvinylidene fluoride nanofiber non-woven fabric, and laminating formed a second polyvinylidene fluoride nanofiber non-woven fabric with thickness of 2.5 μm and fiber diameter of 130 nm. In this case, for electrospinning conditions, spinning solution flow rate is 0.1 mL/h, temperature 22° C., and humidity 20%. After electrospinning, going through a process of thermosetting, and produces a filter.

### EXAMPLE 8

Polyvinylidene fluoride with weight average molecular weight of 50,000 and polyvinylidene fluoride resin for hot-melt with number average molecular weight of 3,000 is dissolved in N,N-Dimethylacetamide (DMAc) and produces spinning solution, and it is inserted to a spinning solution main tank of each unit of the electrospinning apparatus. In each unit, on a bicomponent substrate, electrospinning the spinning solution in conditions of the distance between an electrode and a collector is 40 cm, applied voltage 20 kV, spinning solution flow rate is 0.1 mL/h, temperature 22° C., and humidity 20%, and laminating formed polyvinylidene fluoride nanofiber non-woven fabric with thickness of 3 μm. After electrospinning, going through a process of thermosetting, and produces a filter.

### EXAMPLE 9

Polyvinylidene fluoride resin for hot-melt with number average molecular weight of 3,000 is dissolved in N,N-Dimethylformamide (DMF) by 8 weight % and produces hot-melt solution, and it is inserted to a spinning solution main tank of a first unit of the electrospinning apparatus. Polyvinylidene fluoride with weight average molecular weight of 50,000 is dissolved in N,N-Dimethylacetamide (DMAc) and produces polyvinylidene fluoride spinning solution, and it is inserted to a spinning solution main tank of a second unit of the electrospinning apparatus. In the first unit of the electrospinning apparatus, on a bicomponent substrate, hot-melt solution is electrospun and laminating formed hot-melt electrospinning layer of thickness of 1 μm, and in the second unit, on the hot-melt electrospinning layer, polyvinylidene fluoride nanofiber non-woven fabric of thickness of 3 μm laminating formed. The electrospinning conditions and post process are the same as example 6.

### EXAMPLE 10

Polyvinylidene fluoride with weight average molecular weight of 50,000 and polyvinylidene fluoride resin for hot-melt with number average molecular weight of 3,000 is dissolved in N,N-Dimethylacetamide (DMAc) and produces spinning solution which mixed polyvinylidene fluoride and hot-melt, and it is inserted to a spinning solution main tank of a first unit of the electrospinning apparatus. Also, polyvinylidene fluoride solution which dissolved polyvinylidene fluoride in N,N-Dimethylformamide is inserted to a spinning solution main tank of a second unit of the electrospinning apparatus. In the first unit, on a bicomponent substrate, electrospinning spinning solution which mixed polyvinylidene fluoride and hot-melt, and laminating formed a first polyvinylidene fluoride nanofiber non-woven fabric of thickness of 2.5 μm. In the second unit, on the first polyvinylidene fluoride nanofiber non-woven fabric, consecutively electrospinning the polyvinylidene fluoride solution, and laminating formed a second polyvinylidene fluoride nanofiber non-woven fabric of thickness of 2.5 μm. The electrospinning conditions and post process is the same as example 6.

### COMPARATIVE EXAMPLE 3

The bicomponent substrate used in example 6 is used as filter medium.

### COMPARATIVE EXAMPLE 4

Laminating forming polyvinylidene fluoride nanofiber non-woven fabric which electrospun polyvinylidene fluoride on a cellulose substrate, and produces a filter.

Filtering efficiency of the example 6 to 10 and comparative example 3 is measured according to the filtering efficiency measuring method and shown in table 3.

TABLE 3

| | | | | | Exam- | |
|---|---|---|---|---|---|---|
| | Exam- | Exam- | Exam- | Exam- | ple | Comparative |
| | ple 6 | ple 7 | ple 8 | ple 9 | 10 | Example 3 |
| 0.35 μm | 89 | 93 | 92 | 91 | 92 | 68 |
| DOP | | | | | | |
| Filtering | | | | | | |
| efficiency | | | | | | |
| (%) | | | | | | |

As described above, a filter comprising polyvinylidene fluoride nanofiber non-woven fabric produced through example 6 to 10 of the present invention is excellent in filtering efficiency compared to comparative example 3.

Pressure drop and filter life of the example 7 and comparative example 3 are measured according to the measuring method and shown in Table 4.

TABLE 4

| | Example 7 | Comparative Example3 |
|---|---|---|
| Pressure drop | 4.6 | 8.2 |
| (in · w · g) | | |
| Filter life | 6.5 | 3.9 |
| (month) | | |

According to Table 4, a filter produced through example 7, compared to comparative example 3, has lower pressure drop which results in lower pressure lose and has longer filter life which results in excellence in durability.

Also, in a filter produced by example 6 to 10 does not occur desorption of nanofiber non-woven fabric, but a filter produced by comparative example 4 occurs desorption of nanofiber non-woven fabric.

Therefore, in a filter produced through example 6 to 10, compared to comparative example 4, desorption does not easily occur between nanofiber non-woven fabric and a substrate.

Meanwhile, in an embodiment of the present invention, for substrate, a cellulose substrate is used, and in another embodiment of the present invention, for substrate, general substrate can be used, and for polymer used in polymer spinning solution, polyurethane and polyvinylidene fluoride is used, or solution which mixed polyurethane and polyvinylidene fluoride or polyurethane solution and polyvinylidene fluoride solution can be used. Here, the general substrate is one or more selected among a cellulose substrate, a polyethylene terephthalate substrate, synthetic fiber, natural fiber, and etc.

First, solution which dissolved polyurethane and polyvinylidene fluoride in organic solvent is provided to a spinning solution main tank (8) connected to each unit (10a, 10b) of the electrospinning apparatus, and polyurethane and polyvinylidene fluoride solution provided to the spinning solution main tank (8) is consecutively and quantitatively provided to a plurality of nozzle (12) of a nozzle block (11) provided high voltage through a metering pump (not shown). Polyurethane and polyvinylidene fluoride solution provided from each of the nozzle (12) electrospun and line-focused on a substrate located on a collector (13) flowing high voltage through a nozzle (12), and laminating formed nanofiber non-woven fabric. Here in each unit (10a, 10b) of the electrospinning apparatus (1), a substrate laminated polyvinylidene fluoride nanofiber non-woven fabric is carried from the first unit (10a) to the second unit (10b) by a supply roller (3) operated by driving of a motor (not shown) and an auxiliary carry device (16) driving by rotation of the supply roller (3), the process is repeated, and on the substrate, nanofiber non-woven fabric is consecutively electrospun and laminating formed, and produces a filter.

Also, in the process of electrospinning and laminating forming the polyurethane and polyvinylidene fluoride solution on a substrate, by differing spinning conditions according to each unit (10a, 10b) of the electrospinning apparatus, in the first unit (10a), polyurethane and polyvinylidene nanofiber non-woven fabric with large fiber diameter laminating formed, and in the second unit (10b), polyurethane and polyvinylidene fluoride nanofiber non-woven fabric with small diameter can be consecutively laminating formed.

Also, polyurethane spinning solution which dissolved polyurethane in organic solvent is supplied to the first unit, and polyvinylidene fluoride spinning solution which dissolved

Polyvinylidene fluoride in organic solvent is provided to the second unit, and on a substrate, polyurethane nanofiber non-woven fabric and polyvinylidene fluoride nanofiber non-woven fabric can be laminating formed in order. In other words, by laminating polyurethane nanofiber non-woven fabric on a substrate, and laminating forming polyvinylidene fluoride nanofiber non-woven fabric on the polyurethane nanofiber non-woven fabric, a filter can be produced.

Meanwhile, for spinning solution in an embodiment of the present invention, solution which dissolved polyurethane and polyvinylidene fluoride in organic solvent is used, and in another embodiment, hot-melt can be mixed in the solution. Also, polyurethane solution and polyvinylidene fluoride solution can be mixed with hot-melt and spun in each unit.

According to the method as described above, in the first unit (10a), by electrospinning polyurethane solution on a substrate, laminating formed polyurethane nanofiber non-woven fabric, and in the second unit (10b), by electrospinning polyvinylidene fluoride solution on the polyurethane nanofiber non-woven fabric, laminating forming polyvinylidene fluoride nanofiber non-woven fabric, going through a process of thermosetting, and a filter of the present invention can be produced.

### EXAMPLE 11

By dissolving polyvinylidene fluoride and polyurethane in N,N-Dimethylformamide (DMF) and produces spinning solution, and it is inserted to a spinning solution main tank of each unit of the electrospinning apparatus. In each unit, on a polyethylene terephthalate substrate, electrospinning the spinning solution in conditions of the distance between an electrode and a collector is 40 cm, applied voltage is 20 Kv, spinning solution flow rate is 0.1 mL/h, temperature 22° C., and humidity 20%, and after laminating forming nanofiber non-woven fabric of thickness of 3 μm, and going through thermosetting, and produces a filter.

### EXAMPLE 12

Polyvinylidene fluoride, polyurethane, and polyurethane group resin for hot-melt are dissolved in N,N-Dimethylformamide (DMF) and produces spinning solution, and it is inserted to a spinning solution main tank of each unit. In each unit, spinning solution is electrospun on a polyethylene terephthalate substrate. Other conditions are the same as example 11, and a filter is produced.

### EXAMPLE 13

Polyurethane is dissolved in N,N-Dimethylformamide (DMF) and produces spinning solution and it is inserted to a spinning solution main tank of a first unit, and polyvinylidene fluoride is dissolved in N,N-Dimethylformamide (DMF) and produces spinning solution and it is inserted to a spinning solution main tank of a second unit. In the first unit of the electrospinning apparatus, electrospinning polyurethane on a polyethylene terephthalate substrate, and laminating formed polyurethane nanofiber non-woven fabric of thickness of 2 μm. In the second unit, electrospinning the polyvinylidene fluoride spinning solution on the polyurethane nanofiber non-woven fabric, laminating forming polyvinylidene fluoride nanofiber non-woven fabric of thickness of 2 μm, going through thermosetting, and produces a filter.

### EXAMPLE 14

Polyurethane and polyurethane group resin for hot-melt is dissolved in N,N-Dimethylformamide (DMF) and produces spinning solution, and it is inserted to a spinning solution main tank of a first unit, and polyvinylidene fluoride and polyvinylidene fluoride group resin for hot-melt is dissolved in N,N-Dimethylformamide (DMF) and produces spinning solution, and it is inserted to a spinning solution main tank of a second unit. In the first unit of the electrospinning apparatus, electrospinning polyurethane spinning solution which mixed hot-melt on a polyethylene terephthalate substrate, and laminating formed polyurethane nanofiber non-woven fabric of thickness of 2 μm. In the second unit, electrospinning polyvinylidene fluoride spinning solution which mixed hot-melt on the polyurethane nanofiber non-woven fabric, laminating forming polyvinylidene fluoride nanofiber non-woven fabric of thickness of 2 μm, going through thermosetting, and produces a filter.

### COMPARATIVE EXAMPLE 5

The polyethylene terephthalate substrate used in example 11 is used as filter medium.

### COMPARATIVE EXAMPLE 6

By laminating forming polyvinylidene fluoride nanofiber non-woven fabric which electrospun polyvinylidene fluoride on a polyethylene terephthalate substrate, and a filter is produced.

Filtering efficiency of a filter produced according to the example 11 to 14 and comparative example 5 is measured by the filtering efficiency measuring method and it is shown in Table 5.

TABLE 5

| | Example | Example | Example | Example | Comparative |
|---|---|---|---|---|---|
| | 11 | 12 | 13 | 14 | Example 5 |
| 0.35 μm | 92 | 91 | 92 | 93 | 60 |
| DOP | | | | | |
| Filtering | | | | | |
| efficiency | | | | | |
| (%) | | | | | |

As described above, a filter comprising polyurethane and polyvinylidene fluoride nanofiber non-woven fabric produced through example 11 to 14, compared to comparative example 5, is excellent in filtering efficiency.

Pressure drop and filter life of a filter produced by the example 11 to 14 and comparative example 5 are measured by the pressure drop and filter life measuring method and shown in Table 6.

TABLE 6

| | Example | Example | Example | Example | Comparative |
|---|---|---|---|---|---|
| | 11 | 12 | 13 | 14 | Example 5 |
| Pressure | 4.3 | 4.4 | 4.2 | 4.3 | 5.2 |
| drop | | | | | |
| (in · w · | | | | | |
| g) | | | | | |
| Filter life | 5.2 | 5.3 | 5.1 | 5.3 | 3.8 |
| (month) | | | | | |

According to Table 6, a filter produced through example 11 to 14, compared to comparative example 6, has lower pressure drop which results in lower pressure lose and has longer filter life which results in excellence in durability.

In result of measuring whether desorption or not of nanofiber non-woven fabric and a filter substrate of nanofiber non-woven fabric of produced filter by the measuring method according to example 12 and 14 and comparative example 6, in a filter produced by example 12 and 14 does not occur desorption of nanofiber non-woven fabric, but a filter produced by comparative example 6 occurs desorption of nanofiber non-woven fabric.

Therefore, a filter produced by example 12 and 14, compared to comparative example 6, does not occur desorption well between nanofiber non-woven fabric and a substrate.

Meanwhile, in an embodiment of the present invention, for substrate, a cellulose substrate is used, and in another embodiment of the present invention, for substrate, a general substrate is used, and for polymer, nylon and polyvinylidene fluoride can be used. Here, the general substrate comprises one or more selected from a cellulose substrate, a polyethylene terephthalate substrate, synthetic fiber, natural fiber, and etc., and the nylon preferably comprises nylon 6, nylon 66, nylon 12, and etc.

In order to produce a filter of an embodiment the present invention, for substrate, not a cellulose substrate but a general substrate is applied, in a first unit (10a) of the electrospinning apparatus (1), nylon is electrospun on the substrate, and nylon nanofiber non-woven fabric with fiber diameter of 100 to 150 nm is laminated, and in a second unit (10b), polyvinylidene fluoride is electrospun on the nylon nanofiber non-woven fabric, laminating forming polyvinylidene fluoride nanofiber non-woven fabric with fiber diameter of 80 to 150 nm, and produces a filter.

Here, by differing voltage of unit (10a, 10b) of the electrospinning apparatus, differing diameter of each nanofiber non-woven fabric, and produces a filter, not only spinning voltage but also by adjusting spinning level, diameter of nanofiber non-woven fabric can be different. Also, by adding hot-melt to polymer, making polymer solution and electrospinning, a filter can be produced.

According to the method as described above, in each unit (10a, 10b), laminating forming nylon nanofiber non-woven fabric and polyvinylidene fluoride nanofiber non-woven fabric on the substrate, going through a process of thermosetting in a laminating device (90), and produces a filter of the present invention.

### EXAMPLE 15

Nylon 6 is dissolved in formic acid and produces spinning solution and it is inserted to spinning solution main tank of a first unit, and polyvinylidene fluoride with weight average molecular weight of 50,000 is dissolved in N,N-Dimethylacetamide (DMAc) and produces spinning solution and it is inserted to a spinning solution main tank of a second unit. In the first unit of the electrospinning apparatus, applied voltage is provided 20 kV, electrospinning the nylon 6 spinning solution on a cellulose substrate, and laminating formed nylon nanofiber non-woven fabric of thickness of 2 μm and fiber diameter of 130 nm. In the second unit, applied voltage is provided 20 kV, electrospinning the polyvinylidene fluoride spinning solution on the nylon 6 nanofiber non-woven fabric, laminating forming polyvinylidene fluoride nanofiber non-woven fabric of 2μm and fiber diameter of 130 nm, going through thermosetting, and produces a filter.

### EXAMPLE 16

Polyamide group resin for hot-melt with number average molecular weight of 3,000 is dissolved in formic acid and produces spinning solution, and it is inserted to a spinning solution main tank of a first unit, and nylon 6 is dissolved in formic acid and produces spinning solution, and it is inserted to a spinning solution main tank of a second unit, and polyvinylidene fluoride of weight average molecular weight of 50,000 is dissolved in N,N-Dimetylacetamide (DMAc), and it is inserted to a spinning solution main tank of a third unit. In the first unit of the electrospinning apparatus, electrospinning the hot-melt spinning solution on a cellulose substrate, and laminating formed hot-melt electrospinning layer. In the second unit of the electrospinning apparatus, applied voltage is provided 20 kV, electrospinning the nylon 6 spinning solution on hot-melt electrospinning layer, and laminating formed nylon 6 nanofiber non-woven fabric of thickness of 2 μm and fiber diameter of 130 nm. In the third unit, applied voltage is provided 20 kV, electrospinning the polyvinylidene fluoride spinning solution on the nylon 6 nanofiber non-woven fabric, laminating forming polyvinylidene fluoride nanofiber non-woven fabric of thickness of 2 μm and fiber diameter of 130 nm, going through thermosetting, and produces a filter.

### COMPARATIVE EXAMPLE 7

The cellulose substrate used in example 15 is used as filter medium.

### COMPARATIVE EXAMPLE 8

By laminating forming polyvinylidene fluoride nanofiber non-woven fabric which electrospun polyvinylidene fluoride on a cellulose substrate, a filter is produced.

Filtering efficiency of a filter produced by the example 15 and 16 and comparative example 7 is measured according to the filtering efficiency measuring method and shown in Table 7.

TABLE 7

| | Example 15 | Example 16 | Comparative Example 7 |
|---|---|---|---|
| 0.35 μm DOP | 91 | 92 | 60 |
| Filtering | | | |
| efficiency (%) | | | |

Also, pressure drop and filter life of a filter produced by the example 15 and 16 and comparative example 7 are measured according to the measuring method and shown in Table 8.

TABLE 8

| | Example 15 | Example 16 | Comparative Example 7 |
|---|---|---|---|
| Pressure drop | 4.5 | 4.3 | 5.2 |
| (in · w · g) | | | |
| Filter life | 5.4 | 5.3 | 3.8 |
| (month) | | | |

As described above, a filter comprising polyvinylidene fluoride nanofiber non-woven fabric produced by example 15 and 16 of the present invention, compared to comparative example 7, is excellent in filtering efficiency. Also, according to Table 8, a filter produced by the example 15 and 16, compared to comparative example 7, has lower pressure drop which results in less pressure loss, and longer filter life which results in excellence in durability.

In result of measuring whether desorption or not of nanofiber non-woven fabric of a filter produced according to the example 15 and 16 and comparative example 8, in a filter produced by example 15 and 16 does not occur desorption of nanofiber non-woven fabric, but a filter produced by comparative example 8 occurs desorption of nanofiber non-woven fabric. Therefore, a filter produced by the example 15 and 16, compared to comparative example 8, does not occur desorption well between nanofiber non-woven fabric and a substrate.

Meanwhile, in an embodiment of the present invention, for substrate, a cellulose substrate is used, and in another embodiment of the present invention, a general substrate can be used, and for polymer used in polymer spinning solution, high melting point polyvinylidene fluoride and low melting point polyvinylidene fluoride can be used. Here, the low melting point polyvinylidene fluoride non-woven fabric plays a role as bonding layer between a substrate and high melting point polyvinylidene fluoride nanofiber non-woven fabric, and has effects of preventing desorption of nanofiber.

In order to produce a filter of an embodiment the present invention, for substrate, not a cellulose substrate but a general substrate is applied, in a first unit (10a) of the electrospinning apparatus (1), low melting point polyvinylidene fluoride is electrospun on the substrate, and low melting point polyvinylidene fluoride nanofiber non-woven fabric is laminated, and in a second unit (10b), high melting point polyvinylidene fluoride is electrospun on the low melting point polyvinylidene fluoride nanofiber non-woven fabric, laminating forming high melting point polyvinylidene fluoride nanofiber non-woven fabric, and produces a filter.

Here, by differing voltage of each unit (10a, 10b) of the electrospinning apparatus, differing diameter of each nanofiber non-woven fabric, and produces a filter. Also, by adding hot-melt to polymer, making polymer solution and electrospinning, a filter can be produced.

According to the method as described above, in each unit (10a, 10b), laminating forming low melting point polyvinylidene fluoride nanofiber non-woven fabric and high melting point polyvinylidene fluoride nanofiber non-woven fabric on the substrate in order, going through a process of thermosetting in a laminating device (90), and produces a filter of the present invention.

### EXAMPLE 17

Low melting point polyvinylidene fluoride nanofiber non-woven fabric with number average molecular weight of 5,000 is dissolved in N,N-Dimethlacetamide (DMAc) and produces low melting point polyvinylidene fluoride solution, and it is inserted to a spinning solution main tank of a first unit, and high melting point polyvinylidene fluoride with weight average molecular weight of 50,000 is dissolved in N,N-Dimethlacetamide (DMAc) and produces high melting point polyvinylidene fluoride solution, and it is inserted to a spinning solution main tank of a second unit of the electrospinning apparatus. In the first unit of the electrospinning apparatus, electrospinning the low melting point polyvinylidene fluoride solution on a polyethylene terephthalate substrate with basis weight of 100 g/m², and laminating formed low melting point polyvinylidene fluoride nanofiber non-woven fabric of thickness of 2 μm. In the second unit, electrospinning the high melting point polyvinylidene fluoride solution on the low melting point polyvinylidene fluoride nanofiber non-woven fabric, laminating forming high melting point polyvinylidene fluoride nanofiber non-woven fabric of thickness of 2 μm, going through thermosetting, and produces a filter.

### EXAMPLE 18

In a first unit of the electrospinning apparatus, applied voltage is provided 15 kV, electrospinning the low melting point polyvinylidene fluoride solution on a cellulose substrate, and laminating formed low melting point polyvinylidene fluoride nanofiber non-woven fabric of thickness of 2 μm and fiber diameter of 170 nm. In a second unit, applied voltage is provided 20 kV, electrospinning the high melting point polyvinylidene fluoride solution on the low melting point polyvinylidene fluoride nanofiber non-woven fabric, and laminating formed high melting point polyvinylidene fluoride nanofiber non-woven fabric of thickness of 2 μm and fiber diameter of 130 nm, going through thermosetting, and except for producing a filter, it produces a filter the same as example 17.

### EXAMPLE 19

Low melting point polyvinylidene fluoride nanofiber non-woven fabric of number average molecular weight of 5,000 is dissolved in N,N-Dimethlacetamide (DMAc) and produces low melting point polyvinylidene fluoride solution, and it is inserted to a spinning solution main tank of a first and a third unit of the electrospinning apparatus, and high melting point polyvinylidene fluoride of weight average molecular weight of 50,000 is dissolved in N,N-Dimethlacetamide (DMAc) and produces high melting point polyvinylidene fluoride solution and it is inserted to a spinning solution main tank of a second and a fourth unit of the electrospinning apparatus. In the first unit of the electrospinning apparatus, electrospinning the low melting point polyvinylidene fluoride solution on a cellulose substrate, and laminating formed a first low melting point polyvinylidene fluoride nanofiber non-woven fabric of thickness of 1 μm. In the second unit, applied voltage is provided 15 kV, electrospinning the high melting point polyvinylidene fluoride solution on the first low melting point polyvinylidene fluoride nanofiber non-woven fabric, and laminating formed a first high melting point polyvinylidene fluoride nanofiber non-woven fabric of thickness of 1 μm and fiber diameter of 170 nm. In the third unit of the electrospinning apparatus, electrospinning the low melting point polyvinylidene fluoride solution on the first high melting point polyvinylidene fluoride nanofiber non-woven fabric, and laminating formed a second low melting point polyvinylidene fluoride nanofiber non-woven fabric of thickness of 1 μm. In the fourth unit, applied voltage is provided 20 kV, electrospinning the high melting point polyvinylidene fluoride solution on the second low melting point polyvinylidene fluoride nanofiber non-woven fabric, laminating forming a second high melting point polyvinylidene fluoride nanofiber non-woven fabric of thickness of 1 μm and fiber diameter of 130 nm, going through thermosetting, and produces a filter.

### COMPARATIVE EXAMPLE 9

Polyethylene terephthalate substrate of basis weight of 100 g/m² used in example 17 is used as filter medium.

### COMPARATIVE EXAMPLE 10

By laminating forming polyvinylidene fluoride nanofiber non-woven fabric which electrospun polyvinylidene fluoride on a polyethylene terephthalate substrate, and a filter is produced.

Filtering efficiency of the example 17 to 19 and comparative example 9 is measured by the filtering efficiency measuring method and shown in Table 9.

TABLE 9

| | Example | Example | Example | Comparative |
|---|---|---|---|---|
| | 17 | 18 | 19 | Example 9 |
| 0.35 μm DOP | 91 | 92 | 94 | 62 |
| Filtering | | | | |
| efficiency (%) | | | | |

As described above, a filter comprising low melting point and high melting point polyvinylidene fluoride produced by example 17 to 19, compared to comparative example 9, is excellent in filtering efficiency.

Also, pressure drop and filter life of a filter produced by the example 17 to 19 and comparative example 9 are measured and shown in Table 10.

TABLE 10

| | Example | Example | Example | Comparative |
|---|---|---|---|---|
| | 17 | 18 | 19 | Example 9 |
| Pressure | 4.4 | 4.2 | 4.5 | 5.2 |
| drop | | | | |
| (in · w · g) | | | | |
| Filter life | 5.3 | 5.2 | 5.1 | 3.8 |
| (month) | | | | |

According to Table 10, a filter produced by example 17 and 18, compared to comparative example 9, has low pressure drop which results less pressure loss, and longer filter sustainability which results in excellence in durability.

In result of measuring whether desorption or not of nanofiber non-woven and a filter substrate of a filter produced by the measuring method according to the example 17 to 19 and comparative example 10, in a filter produced by example 17 to does not occur desorption of nanofiber non-woven fabric, but a filter produced by comparative example 10 occurs desorption of nanofiber non-woven fabric.

Therefore, a filter produced through example 17 to 19 of the present invention, compared to comparative example 10, does not occur desorption between nanofiber non-woven fabric and a substrate.

Meanwhile, in the electrospinning apparatus (1) according to the present invention, provided 2 units (10a, 10b) in order, and in an embodiment, it can be provided 3 units (10a, 10b, 10c). In other words, as illustrated in FIG. 23, the electrospinning apparatus (1′) comprises a bottom-up electrospinning apparatus (1), and 3 units (10a, 10b, 10c) are provided consecutively separated in predetermined space in order, and each of the unit (10a, 10b, 10c) individually electrospinning the same polymer spinning solution, or by individually electrospinning polymer spinning solution with different matter, and produces filter material such as non-woven fabric.

In this case, composition of each of the unit (10a, 10b, 10c) is the same as described above, and in the case of 3 units are provided, the last unit (10c) also is provided a voltage generator (14c).

The following description explains manufacturing method of a filter comprising nanofiber of an embodiment of the present invention using the electrospinning apparatus (1′). In an embodiment of the present invention, the electrospinning apparatus uses 3 units (10a, 10b, 10c), and for polymer, uses polyvinylidene fluoride, and for an elongated sheet (15), uses general substrate. The general substrate is a substrate conventionally used in a filter such as a cellulose substrate, a polyethylene terephthalate (PET) substrate, synthetic fiber, natural fiber, and etc.

First, polyvinylidene fluoride is dissolved in organic solvent and produces polyvinylidene fluoride solution, and it is provided to a spinning solution main tank (8) connected to each unit (10a, 10b, 10c) of the electrospinning apparatus, and polyvinylidene fluoride solution provided to the spinning solution main tank (8) is consecutively and quantitatively provided to a plurality of nozzle (12) of a nozzle block (11) flowing high voltage through a metering pump (not shown). Polyvinylidene fluoride solution provided from each of the nozzle (12) electrospun and line-focused on a substrate located on a collector (13) flowing high voltage through a nozzle (12), and laminating forming polyvinylidene fluoride nanofiber non-woven fabric. Here, in each unit (10a, 10b, 10c) of the electrospinning apparatus (1), a substrate laminated polyvinylidene fluoride nanofiber non-woven fabric is carried from a first unit (10a) to a second unit (10b) and to a third unit (10c) in order by a supply roller (3) operated by driving of a motor (not shown) and rotation of an auxiliary carry device (16) driving by rotation of the supply roller (3), the process is repeated, and polyvinylidene fluoride nanofiber non-woven fabric is consecutively electrospun and laminating formed on the substrate.

Also, in the process of electrospinning and laminating forming the polyvinylidene fluoride solution on a substrate, by differing spinning conditions according to each unit (10a, 10b, 10c) of the electrospinning apparatus (1′), in a first unit (10a), a first polyvinylidene fluoride nanofiber non-woven fabric is laminating formed, and in a second unit (10b), polyvinylidene fluoride nanofiber non-woven fabric with smaller fiber diameter than that of the first polyvinylidene fluoride nanofiber non-woven fabric can be consecutively laminating formed, and in a third unit (10c), a third polyvinylidene fluoride nanofiber non-woven fabric with smaller fiber diameter than that of the second polyvinylidene fluoride nanofiber non-woven fabric is consecutively laminating formed.

A voltage generator (14a), which is installed in a first unit (10a) of the electrospinning apparatus (1) and provides voltage to the first unit (10a) and providing low spinning voltage, forms a first polyvinylidene fluoride nanofiber non-woven fabric with fiber diameter of 200 to 250 nm on a substrate, and a voltage generator (14b), which is installed in a second unit (10b) of the electrospinning apparatus (1) and provides voltage to the second unit (10b) and providing high spinning voltage, laminating forms a second polyvinylidene fluoride nanofiber non-woven fabric of fiber diameter of 150 to 200 nm on the first polyvinylidene fluoride nanofiber non-woven fabric, and a voltage generator (14c), which is installed in a third unit (10c) of the electrospinning apparatus (1) and provides voltage to the third unit (10c), provides high spinning voltage, and laminating forms a third polyvinylidene fluoride nanofiber non-woven fabric of fiber diameter of 100 to 150 nm on the second polyvinylidene fluoride nanofiber non-woven fabric. Here, spinning voltage provided by each of the voltage generator (14a, 14b, 14c) is 1 kV or more, and preferably 15 kV or more, and voltage provided by the voltage generator (14a) of the first unit (10a) is lower than voltage provided by the voltage generator (14b) of the second unit (10b).

In an embodiment of the present invention, providing low voltage of the first unit (10a) of the electrospinning apparatus (1), and laminating forming a first polyvinylidene fluoride nanofiber non-woven fabric of fiber diameter of 200 to 250 nm on a substrate, and providing higher voltage in the second unit (10b), and laminating a second polyvinylidene fluoride nanofiber non-woven fabric of fiber diameter of 150 to 200 nm, and providing higher voltage in the third unit (10c), and laminating forming a third polyvinylidene fluoride nanofiber non-woven fabric of fiber diameter of 100 to 150 nm, and produces a filter. However, by differing voltage intensity, spinning is possible.

Here, in order to provide grade of fiber diameter, method of differing voltage intensity provided according to each unit (10a, 10b, 10c) is used, and by differing the distance between a nozzle (12) and a collector (13), nanofiber non-woven fabric with different fiber diameter can be formed. In this case, in the case of spinning solution type and provided voltage intensity are the same, according to the principle of nearer spinning distance, larger fiber diameter, and further spinning distance, smaller fiber diameter, nanofiber non-woven fabric with different fiber diameter can be formed. Also, by adjusting spinning solution concentration and viscosity, or by adjusting an elongated sheet feed speed, fiber diameter can be different.

Moreover, in an embodiment of the present invention, number of unit of the electrospinning apparatus (1′) is limited to 3, but 3 or more units can be provided.

In an embodiment of the present invention, for spinning solution, polyvinylidene fluoride solution which dissolved polyvinylidene fluoride in organic solvent is used, or polyvinylidene fluoride and hot-melt can be mixed and used, and polyvinylidene fluoride solution and hot-melt solution can be provided differently according to each unit and be used.

According to the method as described above, in the first unit (10a), electrospinning polyvinylidene fluoride solution on a substrate, and laminating forming a first polyvinylidene fluoride nanofiber non-woven fabric of fiber diameter of 200 to 250 nm, and in the second unit (10b), electrospinning polyvinylidene fluoride solution on the first polyvinylidene fluoride nanofiber non-woven fabric, and laminating forming a second polyvinylidene fluoride nanofiber non-woven fabric of fiber diameter of 150 to 200 nm, and in the third unit (10c), electrospinning polyvinylidene fluoride solution on the second polyvinylidene fluoride nanofiber non-woven fabric, laminating forming a third polyvinylidene fluoride nanofiber non-woven fabric of fiber diameter of 100 to 150 nm, going through a process of thermosetting, and produces a filter of the present invention.

### EXAMPLE 20

Polyvinylidene fluoride of weight average molecular weight of 50,000 is dissolved in N,N-Dimethylacetamide (DMAc) and produces spinning solution, and it is inserted to a spinning solution main tank of each unit. In the first unit of the electrospinning apparatus, applied voltage is provided 15 kV, electrospinning the spinning solution on a polyethylene terephthalate substrate of basis weight of 100 g/m², and laminating formed a first polyvinylidene fluoride nanofiber non-woven fabric of thickness of 2 μm and fiber diameter of 250 nm. In the second unit, applied voltage is provided 17.5 kV, electrospinning the spinning solution on the first polyvinylidene fluoride nanofiber non-woven fabric, and laminating formed a second polyvinylidene fluoride nanofiber non-woven fabric of thickness of 2 μm and fiber diameter of 170 nm. In the third unit, applied voltage is provided 20 kV, electrospinning the spinning solution on the second polyvinylidene fluoride nanofiber non-woven fabric, and laminating formed a third polyvinylidene fluoride nanofiber non-woven fabric of thickness of 2 μm and fiber diameter of 130 nm.

### EXAMPLE 21

Polyvinylidene fluoride resin for hot-melt of number average molecular weight of 3,000 is dissolved in N,N-Dimethylacetamide (DMAc) in 8 weight % and produces hot-melt solution, and it is inserted to a spinning solution main tank of a first, third, fifth unit of the electrospinning apparatus, and polyvinylidene fluoride of weight average molecular weight of 50,000 is dissolved in N,N-Dimethylacetamide (DMAc) and produces polyvinylidene fluoride solution, and it is inserted to a spinning solution main tank of a second, fourth, sixth unit of the electrospinning apparatus. In the first unit of the electrospinning apparatus, electrospinning the hot-melt solution on a polyethylene terephthalate substrate of basis weight of 100 g/m², and laminating formed a first hot-melt electrospinning layer of thickness of 1 μm. In the second unit, applied voltage is provided 15 kV, electrospinning the polyvinylidene fluoride solution on the first hot-melt electrospinning layer, and laminating formed a first polyvinylidene fluoride nanofiber non-woven fabric of thickness of 2 μm and fiber diameter of 250 nm.

In the third unit of the electrospinning apparatus, electrospinning the hot-melt solution on the first polyvinylidene fluoride nanofiber non-woven fabric, and laminating formed a second hot-melt electrospinning layer of thickness of 1 μm. In the fourth unit, applied voltage is provided 17.5 kV, electrospinning the polyvinylidene fluoride solution on the second hot-melt electrospinning layer, and laminating formed a second polyvinylidene fluoride nanofiber non-woven fabric of thickness of 2 μm and fiber diameter of 170 nm.

In the fifth unit of the electrospinning apparatus, electrospinning the hot-melt solution on the second polyvinylidene fluoride nanofiber non-woven fabric, and laminating formed a third hot-melt electrospinning layer of thickness of 1 μm. In the sixth unit, applied voltage is provided 20 kV, electrospinning the polyvinylidene fluoride solution on the third hot-melt electrospinning layer, laminating forming a third polyvinylidene fluoride nanofiber non-woven fabric of thickness of 2 μm and fiber diameter of 130 nm.

### COMPARATIVE EXAMPLE 11

The polyethylene terephthalate substrate of basis weight of 100 g/m² used in example 20 is used as filter medium.

### COMPARATIVE EXAMPLE 12

By laminating forming polyvinylidene fluoride nanofiber non-woven fabric which electrospun polyvinylidene fluoride on a polyethylene terephthalate substrate, a filter is produced.

Filtering efficiency of the example 20 and 21 and comparative example 11 is measured by the filtering efficiency measuring method and shown in Table 11.

TABLE 11

| | Example 20 | Example 21 | Comparative Example 11 |
|---|---|---|---|
| 0.35 μm DOP | 91 | 92 | 63 |
| Filtering | | | |
| efficiency (%) | | | |

As described above, a filter produced by example 20 and 21 of the present invention, compared to comparative example 11, is excellent in filtering efficiency.

Also, pressure drop and filter life of a filter produced by the example 20 and 21 and comparative example 11 are measured and shown in Table 12.

TABLE 12

| | Example | Example | Comparative |
|---|---|---|---|
| | 20 | 21 | Example 11 |
| Pressure drop (in · w · g) | 4.6 | 4.5 | 5.2 |
| Filter life (month) | 5.3 | 5.4 | 3.8 |

According to Table 12, a filter produced by example 20 and 21 of the present invention, compared to comparative example 11, has low pressure drop which results in less pressure loss, and longer filter sustainability which results in excellence in durability.

In result of measuring whether desorption or not of nanofiber non-woven fabric and a filter substrate of filter produced by example 20 and 21 and comparative example 12 according to the measuring method, in a filter produced by example 20 and 21 does not occur desorption of nanofiber non-woven fabric, but a filter produced by comparative example 12 occurs desorption of nanofiber non-woven fabric.

Therefore, a filter produced through example 20 and 21, compared to comparative example 12, does not occur desorption well between nanofiber non-woven fabric and a substrate.

Meanwhile, in the rear-end of a unit (10b) located in the rear-end of the electrospinning apparatus (1), a laminating device (90) is provided, and in another embodiment, a laminating device (100) can be provided between a unit (10b) located in the rear-end and a laminating device (90). In other words, as illustrated in FIG. 25, in the rear-end of the unit (10b) of the electrospinning apparatus (1″), a laminating device (100) is provided, and in bottom of an elongated sheet (15) laminated nanofiber non-woven fabric, a substrate (not shown) is laminated. The laminating device (100) laminates a substrate (not shown) on nanofiber non-woven fabric spun polymer spinning solution on an elongated sheet (15) through each unit (10a, 10b).

In this case, the laminating device (100) is provided in bottom of the nanofiber non-woven fabric, and a substrate provided through the laminating device (100) is laminated on bottom side of nanofiber non-woven fabric.

In an embodiment of the present invention, the laminating device (100) is provided in bottom of nanofiber non-woven fabric to laminate on bottom side of nanofiber non-woven fabric, and the laminating device (100) can be provided in stop of nanofiber non-woven fabric to laminate upper side of nanofiber non-woven fabric.

In an embodiment of the present invention, the electrospinning apparatus (1″) uses 2 units (10a, 10b), for polymer, uses nylon, and for an elongated sheet (15), uses a bicomponent substrate. Nylon used in the present invention comprises nylon 6, nylon 66, nylon 46, nylon 12, and etc. or one selected among group comprising their polymer. Also, Fiber forming polymer of a bicomponent substrate used in an embodiment of the present invention can be polyester comprising polyethylene terephthalate, polyethylene naphthalate, polypropylene terephthalate, and polybutylene terephthalate, and polypropylene terephthalate also is polybutylene terephthalte such as polytrimethylene terephthalte and polytetramethylene terephthalte.

In order to produce a filter of an embodiment the present invention, nylon is dissolved in organic solvent and produces nylon solution which is provided to a spinning solution main tank (8) connected to each unit (10a, 10b) of the electrospinning apparatus, and nylon solution provided to the spinning solution main tank (8) is consecutively and quantitatively provided in a plurality of nozzle (12) of a nozzle block (11) provided high voltage through a metering pump (not shown). Nylon solution provided from each of the nozzle (12) electrospun and line-focused on a bicomponent substrate located on a collector (13) flowing high voltage through a nozzle (12), and laminating forming nylon nanofiber non-woven fabric.

Meanwhile, in each unit (10a, 10b) of the electrospinning apparatus (1″), a bicomponent substrate laminated nylon nanofiber non-woven fabric is carried from the first unit (10a) to the second unit (10b) by a supply roller (3) operated by driving of a motor (not shown) and rotation of an auxiliary carry device (16) driving by rotation of the supply roller (3), the process is repeated, and on a bicomponent substrate, nylon nanofiber non-woven fabric is consecutively electrospun and laminating formed.

Also, in the process of electrospinning and laminating forming the nylon solution on a bicomponent substrate, by differing spinning conditions according to each unit (10a, 10b) of the electrospinning apparatus, in the first unit (10a), laminating forming nylon nanofiber non-woven fabric with large fiber diameter, and in the second unit (10b), consecutively laminating forming nylon nanofiber non-woven fabric with small fiber diameter.

In this case, a voltage generator (14a) installed in the first unit (10a) of the electrospinning apparatus (1″) and providing voltage to the first unit (10a) is provided low spinning voltage, and forms nylon nanofiber non-woven fabric of fiber diameter of 150 to 300 nm on a bicomponent substrate, and a voltage generator (14b) installed in the second unit (10b) and providing voltage to the second unit (10b) is provided high spinning voltage, laminating forming nylon nanofiber non-woven fabric of fiber diameter of 100 to 150 nm on the nylon nanofiber non-woven fabric of fiber diameter of 150 to 300 nm. Here, spinning voltage provided by each of the voltage generator (14a, 14b) is 1 kV or more, and preferably 15 kV or more, and voltage provided by the voltage generator (14a) of the first unit (10a) is lower than voltage provided by the voltage generator (14b) of the second unit (10b).

In an embodiment of the present invention, voltage of the first unit (10a) of the electrospinning apparatus (1″) is provided low, laminating nylon nanofiber non-woven fabric of fiber diameter of 150 to 300 nm on a bicomponent substrate, and voltage of the second unit (10b) is provided high, laminating forming nylon nanofiber non-woven fabric of fiber diameter of 100 to 150 nm, and produces a filter. However, by differing voltage intensity, nylon nanofiber non-woven fabric of fiber diameter of 100 to 150 nm spun and laminating formed in the first unit (10a), and nylon nanofiber non-woven fabric of fiber diameter of 150 to 300 nm can be spun in the second unit (10b).

Also, number of unit of the electrospinning apparatus (1″) comprises 3 or more, and by differing voltage according to each unit, a filter laminating forming 3 or more layers of nylon nanofiber non-woven fabric with different fiber diameter on a bicomponent substrate can be produced.

Here, in order to provide grade of fiber diameter, a method of differing voltage intensity provided according to each unit (10a, 10b) is used, or by adjusting the distance between a nozzle (12) and a collector (13), nanofiber non-woven fabric with different fiber diameter can be formed. In the case of spinning solution type and provided voltage intensity are the same, according to the principle of the nearer spinning distance is, the larger fiber diameter is, and the further spinning distance is, the smaller fiber diameter is, nanofiber non-woven fabric with different fiber diameter can be formed. Also, by adjusting density and viscosity of spinning solution, or by adjusting moving speed of an elongated sheet, fiber diameter can be different.

According to the method as described above, after laminating forming nylon nanofiber non-woven fabric in each unit (10a, 10b), in a laminating device (100) located in the rear-end of the electrospinning apparatus (1″), a polyethylene terephthalate substrate is laminated one side of the bicomponent substrate not laminating formed the nylon nanofiber non-woven fabric, and going through a process of thermosetting in a laminating device (90), and a filter can be produced.

### EXAMPLE 22

Nylon 6 is dissolved in formic acid and produces spinning solution, and it is inserted in a spinning solution main tank of each unit of the electrospinning apparatus. In each unit, electrospinning the spinning solution on one side of a bicomponent substrate of basis weight of 30 g/m², and laminating formed nylon 6 nanofiber non-woven fabric of thickness of 3 μm. After electrospinning, a polyethylene terephthalate substrate of basis weight of 150 g/m² is laminated on another side of a bicomponent substrate not laminated the nylon nanofiber non-woven fabric, and in a laminating device, going through thermosetting, and produces a filter comprising nylon nanofiber non-woven fabric and a bicomponent substrate and a polyethylene terephthalate substrate. In this case, electrospinning is performed in conditions of applied voltage is 20 kV, spinning solution flow rate is 0.1 mL/h, temperature 22° C., and humidity 20%.

### EXAMPLE 23

Except for using polyethylene terephthalate substrate of basis weight of 55 g/m², it produces a filter in the same conditions as example 22.

### EXAMPLE 24

Nylon 6 is dissolved in formic acid and produces spinning solution, and it is inserted in a spinning solution main tank of each unit of the electrospinning apparatus. In a first unit of the electrospinning apparatus, applied voltage is provided 15 kV, electrospinning the spinning solution on one side of a bicomponent substrate of basis weight of 30 g/m², and laminating formed a first nylon 6 nanofiber non-woven fabric of thickness of 2.5 μm and fiber diameter of 250 nm. In a second unit of the electrospinning apparatus, applied voltage is provided 20 kV, electrospinning the spinning solution on the first nylon 6 nanofiber non-woven fabric, and laminating formed second first nylon 6 nanofiber non-woven fabric of thickness of 2.5 μm and fiber diameter of 130 nm. After electrospinning, polyethylene terephthalate substrate of basis weight of 150 g/m² is laminated on another side of the bicomponent substrate not laminated the first nylon 6 nanofiber non-woven fabric, and in a laminating device, going through thermosetting laminating formed fabrics in order of a polyethylene terephthalate substrate, a bicomponent substrate, a first nylon 6 nanofiber, a second nylon 6 nanofiber non-woven fabric, and produces a filter.

### EXAMPLE 25

Except for using polyethylene terephthalate substrate of basis weight of 55 g/m², it produces a filter in the same conditions as example 24.

### COMPARATIVE EXAMPLE 13

Polyethylene terephthalate substrate used in example 22 is used as filter medium.

### COMPARATIVE EXAMPLE 14

By laminating forming nylon 6 nanofiber non-woven fabric which electrospun nylon 6 on a polyethylene terephthalate substrate, and produces a filter.

Filtering efficiency of the example 22 and 23 and comparative example 13 is measured according to the filtering efficiency measuring method and shown in Table 13.

TABLE 13

| | | | Comparative |
|---|---|---|---|
| | Example 22 | Example 23 | Example 13 |
| 0.35 μm DOP | 90 | 93 | 65 |
| Filtering | | | |
| efficiecny (%) | | | |

As described above, a filter comprising nylon nanofiber non-woven fabric and a bicomponent substrate produced by example 22 and 23, compared to comparative example 13, is excellent in filtering efficiency.

Also, pressure drop and filter sustainability of a filter produced by the example 24 and 25 and comparative example 13 are measured and shown in Table 14.

TABLE 14

| | | | Comparative |
|---|---|---|---|
| | Example 24 | Example 25 | Example 13 |
| Pressure drop | 4.1 | 4.2 | 8.0 |
| (in · w · g) | | | |
| Filter life | 6.2 | 6.0 | 4.1 |
| (month) | | | |

According to Table 14, a filter produced by example 24 and 25 of the present invention, compared to comparative example 13, has lower pressure drop which results in less pressure loss, and longer filter sustainability which results in excellence in durability.

In result of measuring whether desorption or not of nanofiber non-woven fabric and a filter substrate of filter produced by example 22 to 25 and comparative example 14 according to the measuring method, in a filter produced by example 22 to 25 does not occur desorption of nanofiber non-woven fabric, but a filter produced by comparative example 14 occurs desorption of nanofiber non-woven fabric.

Therefore, a filter produced by example 22 to 25 of the present invention, compared to comparative example 14, does not occur desorption well between nanofiber non-woven fabric and a substrate.

Meanwhile, in an embodiment of the present invention, for nanofiber non-woven fabric laminated on a bicomponent substrate laminated on a PET substrate, nylon nanofiber non-woven fabric is used, and in another embodiment, polyvinylidene fluoride nanofiber non-woven fabric can be used.

Meanwhile, in order to produce a filter of an embodiment of the present invention, it is produced according to the manufacturing method as described above, for substrate, for nanofiber non-woven fabric, by electrospinning not nylon but polyvinylidene fluoride, and forming polyvinylidene fluoride nanofiber non-woven fabric, and a filter is produced.

Here, by differing voltage of unit (10a, 10b) of the electrospinning apparatus (1″), and by differing diameter of each nanofiber non-woven fabric, a filter can be produced. Also, by adding hot-melt in polymer and making polymer solution and electrospinning, a filter can be produced. According to the method as described above, in each unit (10a, 10b), after consecutively laminating forming polyvinylidene fluoride nanofiber non-woven fabric on the bicomponent substrate, in a laminating device (100) located in the rear-end of the electrospinning apparatus (1″), a polyethylene terephthalate substrate is adhered to another side of the bicomponent substrate not laminating formed the polyvinylidene fluoride nanofiber non-woven fabric, going through a process of thermosetting in a laminating device (90), and a filter is produced. In this case, basis weight of the polyethylene terephthalate substrate preferably is 50 to 300 g/m².

### EXAMPLE 26

Polyvinylidene fluoride of weight average molecular weight of 50,000 is dissolved in N,N-Dimethylacetamide (DMAc) and produces spinning solution, and it is inserted to a spinning solution main tank of each unit of each electrospinning apparatus. In each unit, electrospinning the spinning solution on one side of a bicomponent substrate of basis weight of 30 g/m², and laminating formed polyvinylidene fluoride nanofiber non-woven fabric of thickness of 3 μm. After electrospinning, bonding a polyethylene terephthalate substrate of basis weight of 150 g/m² on another side of the bicomponent substrate not laminated to the polyvinylidene fluoride nanofiber non-woven fabric through a laminating device, going through thermosetting in a laminating device, and finally produces a filter comprising polyvinylidene fluoride nanofiber non-woven fabric, a bicomponent substrate, and a polyethylene terephthalate substrate. In this case, applied voltage is 20 kV, spinning solution flow rate is 0.1 mL/h, temperature 22° C., and humidity 20%.

### EXAMPLE 27

Instead of using a polyethylene terephthalate substrate of basis weight of 55 g/m², a filter is produced in the same conditions as example 26.

### EXAMPLE 28

Polyvinylidene fluoride of weight average molecular weight of 50,000 is dissolved in N,N-Dimethylacetamide (DMAc) and produces spinning solution, and it is inserted to a spinning solution main tank of each unit of the electrospinning apparatus. In the first unit of the electrospinning apparatus, applied voltage is provided 15 kV, electrospinning the spinning solution on one side of a bicomponent substrate of basis weight of 30 g/m², and laminating formed a first polyvinylidene fluoride nanofiber non-woven fabric of thickness of 2.5 μm and fiber diameter of 250 nm. In the second unit of the electrospinning apparatus, applied voltage is provided 20 kV, electrospinning the spinning solution on the first polyvinylidene fluoride nanofiber non-woven fabric, and laminating formed a second polyvinylidene fluoride nanofiber non-woven fabric of thickness of 2.5 μm and fiber diameter of 130 nm. After electrospinning, a polyethylene terephthalate substrate of basis weight of 150 g/m² is laminated another side of the bicomponent substrate not laminated to the first polyvinylidene fluoride nanofiber non-woven fabric through a laminating device, in a laminating device, thermosetting fabric laminating formed in order of the polyethylene terephthalate substrate, the bicomponent substrate, the first polyvinylidene fluoride nanofiber, the second polyvinylidene fluoride nanofiber non-woven fabric, and produces a filter.

### EXAMPLE 29

Instead of using a polyethylene terephthalate substrate of basis weight of 55 g/m², a filter is produced in the same conditions as example 28.

### COMPARATIVE EXAMPLE 15

The polyethylene terephthalate substrate used in example 26 is used as filter medium.

### COMPARATIVE EXAMPLE 16

By laminating forming polyvinylidene fluoride nanofiber non-woven fabric which electrospun polyvinylidene fluoride on a polyethylene terephthalate substrate, and produces a filter.

Filtering efficiency of the example 26 and 27 and comparative example 15 is measured by the filtering efficiency measuring method and shown in Table 15.

TABLE 15

| | | | Comparative |
|---|---|---|---|
| | Example 26 | Example 27 | Example 15 |
| 0.35 μm DOP | 91 | 92 | 63 |
| Filtering | | | |
| efficiency (%) | | | |

As described above, a filter comprising polyvinylidene fluoride nanofiber non-woven fabric and a bicomponent substrate produced by example 26 and 27, compared to comparative example 15, is excellent in filtering efficiency.

Also, pressure drop and filer sustainability of example 28 and 29 and comparative example 15 are measured and shown in Table 16.

TABLE 16

| | | | Comparative |
|---|---|---|---|
| | Example 28 | Example 29 | Example 15 |
| Pressure drop | 4.2 | 4.3 | 8.0 |
| (in · w · g) | | | |
| Filter | 6.2 | 6.0 | 4.0 |
| life (month) | | | |

According to Table 16, a filter produced by example 28 and 29 of the present invention, compared to comparative example 15, has lower pressure drop which results in less pressure loss, and longer filter sustainability which results in excellence in durability.

In result of measuring whether desorption or not of nanofiber non-woven fabric and a filter substrate of filter produced by example 26 to 29 and comparative example 16 according to the measuring method, in a filter produced by example 26 to 29 does not occur desorption of nanofiber non-woven fabric, but a filter produced by comparative example 15 occurs desorption of nanofiber non-woven fabric.

Therefore, a filter produced through example 26 to 29 of the present invention, compared to comparative example 16, does not occur desorption well between nanofiber non-woven fabric and a substrate.

Meanwhile, in an embodiment of the present invention, for nanofiber non-woven fabric laminated on a bicomponent substrate laminated on a polyethylene terephthalate (PET) substrate, polyvinylidene fluoride nanofiber non-woven fabric is used, and in another embodiment, high melting point and low melting point polyvinylidene fluoride nanofiber non-woven fabric can be used. Also, the PET substrate can be needle felt type PET substrate.

In the case of using the high melting point and low melting point polyvinylidene fluoride nanofiber, there are effects such as separation between nanofiber and a substrate does not occur even not by using adhesive such as hot-melt.

In order to produce a filter of an embodiment of the present invention, the manufacturing method as described above is used, by electrospinning spinning solution which mixed high melting point and low melting point polyvinylidene fluoride on a bicomponent substrate in each unit (10a, 10b) of the electrospinning apparatus (1″), after laminating forming high melting point and low melting point polyvinylidene fluoride nanofiber non-woven fabric, in a laminating device (100) located in the rear-end of the electrospinning apparatus (1″), a polyethylene terephthalate (PET) substrate is laminated to one side of the bicomponent substrate not laminating formed the polyvinylidene fluoride nanofiber non-woven fabric, going through a process of thermosetting in a laminating device (90), and produces a filter. Here, the polyethylene terephthalate substrate can be needle felt type polyethylene terephthalate substrate.

### EXAMPLE 30

High melting point polyvinylidene fluoride of weight average molecular weight of 50,000 and low melting point polyvinylidene fluoride of weight average molecular weight of 5,000 is dissolved in N,N-Dimethylacetamide (DMAc) and produces spinning solution, and it is inserted to a spinning solution main tank of each unit of each electrospinning apparatus. In each unit, electrospinning the spinning solution on one side of a bicomponent substrate of basis weight of 30 g/m², and laminating formed polyvinylidene fluoride nanofiber non-woven fabric of thickness of 3 μm. After electrospinning, bonding a polyethylene terephthalate substrate of basis weight of 150 g/m² on another side of the bicomponent substrate not adhered to the polyvinylidene fluoride nanofiber non-woven fabric, and in a laminating device, going through thermosetting, and finally produces a filter comprising polyvinylidene fluoride nanofiber non-woven fabric, a bicomponent substrate, and a polyethylene terephthalate substrate. In this case, electrospinning is performed in conditions of applied voltage is 20 kV, spinning solution flow rate is 0.1 mL/h, temperature 22° C., and humidity 20%.

### EXAMPLE 31

Except for using needle felt type polyethylene terephthalate substrate, it produces a filter in the same conditions as example 30.

### EXAMPLE 32

High melting point polyvinylidene fluoride of weight average molecular weight of 50,000 and low melting point polyvinylidene fluoride of weight average molecular weight of 5,000 is dissolved in N,N-Dimethylacetamide (DMAc) and produces spinning solution, and it is inserted to a spinning solution main tank of each unit of the electrospinning apparatus. In the first unit of the electrospinning apparatus, applied voltage is provided 15 kV, electrospinning the spinning solution on one side of a bicomponent substrate of basis weight of 30 g/m², and laminating formed a first polyvinylidene fluoride nanofiber non-woven fabric of thickness of 2.5 μm and fiber diameter of 250 nm. In the second unit of the electrospinning apparatus, applied voltage is provided 20 kV, electrospinning the spinning solution on the first polyvinylidene fluoride nanofiber non-woven fabric, and laminating formed a second polyvinylidene fluoride nanofiber non-woven fabric of thickness of 2.5 μm and fiber diameter of 130 nm. After electrospinning, a polyethylene terephthalate substrate of basis weight of 150 g/m² is laminated to another side of the bicomponent substrate not adhered to the first polyvinylidene fluoride nanofiber non-woven fabric, and in a laminating device, thermosetting fabric laminating formed the polyethylene terephthalate substrate, the bicomponent substrate, the first polyvinylidene fluoride nanofiber, the second polyvinylidene fluoride nanofiber non-woven fabric in order, and produces a filter.

### EXAMPLE 33

Except for using needle felt type polyethylene terephthalate substrate, it produces a filter in the same conditions as example 32.

### COMPARATIVE EXAMPLE 17

The polyethylene terephthalate substrate used in example 30 is used as filter medium.

### COMPARATIVE EXAMPLE 18

By laminating forming polyvinylidene fluoride nanofiber non-woven fabric which electrospun polyvinylidene fluoride on a polyethylene terephthalate substrate, and produces a filter.

Filtering efficiency of example 30 and 31 and comparative example 17 is measured by the filtering efficiency measuring method and shown in Table 17.

TABLE 17

| | | | Comparative |
|---|---|---|---|
| | Example 30 | Example 31 | Example 17 |
| 0.35 μm DOP | 93 | 92 | 63 |
| Filtering | | | |
| efficiency (%) | | | |

As described above, a filter comprising high melting point and low melting point polyvinylidene fluoride nanofiber non-woven fabric produced by example 30 and 31 of the present invention, compared to comparative example 17, is excellent in filtering efficiency.

Also, pressure drop and filter life of a filter produced by example 32 and 33 and comparative example 17 are measured and shown in Table 18.

TABLE 18

| | | | Comparative |
|---|---|---|---|
| | Example 32 | Example 33 | Example 17 |
| Pressure | 4.1 | 4.2 | 5 |
| drop (in · w · g) | | | |
| Filter | 6.3 | 6.3 | 5.4 |
| life (month) | | | |

According to Table 18, a filter produced through example 32 and 33, compared to comparative example 17, has lower pressure drop which results in lower pressure lose and has longer filter sustainability which results in excellence in durability.

In result of measuring whether desorption or not of nanofiber non-woven fabric and a filter substrate of a filter produced by example 30 to 33 and comparative example 18 by the measuring method, in a filter produced by example 30 to 33 does not occur desorption of nanofiber non-woven fabric, but a filter produced by comparative example 18 occurs desorption of nanofiber non-woven fabric.

Therefore, a filter produced through example 30 to 33 of the present invention, compared to comparative example 18, does not occur desorption well between nanofiber non-woven fabric and a substrate.

Meanwhile, in an embodiment of the present invention, for nanofiber non-woven fabric laminated on a bicomponent substrate laminated on a PET substrate, polyvinylidene fluoride nanofiber non-woven fabric is used, and in another embodiment, a bicomponent substrate is used instead of the PET substrate, and a filter comprising polyvinylidene fluoride nanofiber non-woven fabric laminated on a bicomponent substrate of 2 layers can be produced.

In order to produce a filter of an embodiment of the present invention, the manufacturing method as described above is used, in each unit (10a, 10b) of the electrospinning apparatus (1″), after laminating forming polyvinylidene fluoride nanofiber non-woven fabric on a first bicomponent substrate, in a laminating device (100) located in the rear-end of the electrospinning apparatus (1″), a second bicomponent substrate is laminated on one side of the first bicomponent substrate not laminating formed the polyvinylidene fluoride nanofiber non-woven fabric, and going through thermosetting in a laminating device (90), and produces a filter.

Here, by differing voltage of unit (10a, 10b) of the electrospinning apparatus, and by differing diameter of each nanofiber non-woven fabric, a filter can be produced. Also, by adding hot-melt in polymer and making polymer solution and electrospinning, a filter can be produced. Also, a melting point of the second bicomponent substrate is preferably 130 to 170° C.

According to the method as described above, in each unit (10a, 10b), laminating formed polyvinylidene fluoride nanofiber non-woven fabric on the first bicomponent substrate, through a laminating device (100), bonding the second bicomponent substrate below the first bicomponent substrate, and going through thermosetting in a laminating device (90), a filter of the present invention is produced.

### EXAMPLE 34

Polyvinylidene fluoride of weight average molecular weight of 50,000 is dissolved in N,N-Dimethylacetamide (DMAc) and produces spinning solution, and in is inserted to a spinning solution main tank of each unit of the electrospinning apparatus. In each unit, on one side of a bicomponent substrate with a melting point of 100° C., in conditions of the distance between an electrode and a collector is 40 cm, applied voltage is 20 kV, spinning solution flow rate is 0.1 mL/h, temperature 22° C., and humidity 20%, electrospinning the spinning solution, and laminating formed polyvinylidene fluoride nanofiber non-woven fabric of thickness of 3 μm. After electrospinning, in a laminating device located in the rear-end of the electrospinning apparatus, on another side of the bicomponent substrate with a melting point of 100° C. not laminated polyvinylidene fluoride nanofiber, bonding a bicomponent substrate with a melting point of 140° C., and putting pressure in a laminating device, and finally produces a filter.

### EXAMPLE 35

The bicomponent substrate with a melting point of 100° C. in example 34, except for using a water-proof coating bicomponent substrate, it produces a filter in the same method as example 34.

### COMPARATIVE EXAMPLE 19

The bicomponent substrate with a melting point of 140° C. in example 34 is used as filter medium.

### COMPARATIVE EXAMPLE 20

By laminating forming polyvinylidene fluoride nanofiber non-woven fabric which electrospun polyvinylidene fluoride on a cellulose substrate, and produces a filter.

Filtering efficiency of example 34 and 35 and comparative example 19 is measured according to the filtering efficiency measuring method and shown in Table 19. Also, pressure drop and filter life of filter produced by example 34 and 35 and comparative example 19 are measured and shown in Table 20.

TABLE 19

| | | | Comparative |
|---|---|---|---|
| | Example 34 | Example 35 | example 19 |
| 0.35 μm DOP | 90 | 91 | 65 |
| Filtering | | | |
| efficiency (%) | | | |

TABLE 20

| | | | Comparative |
|---|---|---|---|
| | Example 34 | Example 35 | example 19 |
| Pressure drop | 4.1 | 4.2 | 8.0 |
| (in · w · g) | | | |
| Filter life (month) | 6.2 | 6.0 | 4.0 |

As described above, a filter comprising polyvinylidene fluoride nanofiber non-woven fabric and a bicomponent substrate produced by example 34 and 35 of the present invention, compared to comparative example 19, is excellent in filtering efficiency.

According to Table 20, a filter produced through example 34 and 35, compared to comparative example 19, has lower pressure drop which results in lower pressure lose and has longer filter sustainability which results in excellence in durability.

In result of measuring whether desorption or not of nanofiber non-woven fabric and a filter substrate of a filter produced by example 34 and 35 and comparative example 20 by the measuring method, in a filter produced by example 34 and 35 does not occur desorption of nanofiber non-woven fabric, but in a filter produced by comparative example 20 occurs desorption of nanofiber non-woven fabric.

Therefore, a filter produced through example 34 and 35 of the present invention, compared to comparative example 20, does not occur desorption well between nanofiber non-woven fabric and a substrate.

Meanwhile, in an embodiment of the present invention, it has a structure laminated polyvinylidene fluoride nanofiber non-woven fabric on a bicomponent substrate of 2 layers, and in another embodiment, instead of the bicomponent substrate of 2 layers, polyethylene terephthalate substrate of 2 layers is used, and the polyvinylidene fluoride nanofiber non-woven fabric can be polyvinylidene fluoride nanofiber non-woven fabric of 2 layers with different fiber diameter.

In order to produce a filter of an embodiment of the present invention, the manufacturing method as described above is used, in the process of electrospinning and laminating forming the polyvinylidene fluoride solution on a first polyethylene terephthalate substrate, by differing spinning conditions according to each unit (10a, 10b) of the electrospinning apparatus, in the first unit (10a), laminating forming polyvinylidene fluoride nanofiber non-woven fabric with large fiber diameter, and in the second unit (10b), consecutively laminating formed polyvinylidene fluoride nanofiber non-woven fabric with small fiber diameter. Here, a voltage generator (14a) providing voltage to the first unit (10a) provides low spinning voltage, and forms a first polyvinylidene fluoride nanofiber non-woven fabric of fiber diameter of 150 to 300 nm on a first polyethylene terephthalate substrate, and a voltage generator (14b) installed in the second unit (10b) and providing voltage to the second unit (10b) provides high spinning voltage, and laminating forms a second polyvinylidene fluoride nanofiber non-woven fabric of fiber diameter of 100 to 150 nm on the first polyvinylidene fluoride nanofiber non-woven fabric. Also, by differing voltage intensity, in the first unit (10a) can be applied high voltage and the in the second unit (10b) can be applied low voltage.

Also, in an embodiment of the present invention, for spinning solution, polyvinylidene fluoride solution which dissolved polyvinylidene fluoride in organic solvent is used, polyvinylidene fluoride and hot-melt can be mixed and used, and polyvinylidene fluoride solution and hot-melt solution are provided differently according to each unit and can be used.

According to the method as described above, in the first unit (10a), electrospinning polyvinylidene fluoride solution on one side of a first polyethylene terephthalate substrate, and laminating formed a first polyvinylidene fluoride nanofiber non-woven fabric of fiber diameter of 150 to 300 nm. In the second unit (10b), electrospinning polyvinylidene fluoride solution on the first polyvinylidene fluoride nanofiber non-woven fabric, and laminating formed a second polyvinylidene fluoride nanofiber non-woven fabric of fiber diameter of 100 to 150 nm. After, in a laminating device (100) located in the rear-end of the electrospinning apparatus (1), bonding a second polyethylene terephthalate substrate on another side of the first polyethylene terephthalate substrate not laminating formed the first polyvinylidene fluoride nanofiber non-woven fabric, and going through a process of thermosetting in a laminating device (90), and produces a filter of the present invention.

### EXAMPLE 36

Polyvinylidene fluoride of weight average molecular weight of 50,000 is dissolved in N,N-Dimethylacetamide (DMAc) and produces spinning solution, and it is inserted to a spinning solution main tank of each unit of the electrospinning apparatus. In the first unit of the electrospinning apparatus, applied voltage is provided 15 kV, electrospinning the spinning solution on one side of a polyethylene terephthalate substrate of basis weight of 30 g/m², and laminating formed a first polyvinylidene fluoride nanofiber non-woven fabric of thickness of 2.5 μm and fiber diameter of 250 nm. In the second unit of the electrospinning apparatus, applied voltage is provided 20 kV, electrospinning the spinning solution on the first polyvinylidene fluoride nanofiber non-woven fabric, and laminating formed a second polyvinylidene fluoride nanofiber non-woven fabric of thickness of 2.5 μm and fiber diameter of 130 nm. In this case, for electrospinning conditions, spinning solution flow rate is 0.1 mL/h, temperature 22° C., and humidity 20%. After electrospinning, in a laminating device located in the rear-end of the electrospinning apparatus, boding a polyethylene terephthalate substrate of basis weight of 100 g/m² on another side of the polyethylene terephthalate substrate of basis weight of 30 g/m² and one side not laminated to the first polyvinylidene fluoride nanofiber non-woven fabric, and going through thermosetting in a laminating device, and finally produces a filter.

### EXAMPLE 37

Polyvinylidene fluoride of weight average molecular weight of 50,000 and polyvinylidene fluoride resin for hot-melt of number average molecular weight of 3,000 is dissolved in N,N-Dimethylacetamide (DMAc) and produces spinning solution, and it is inserted to a spinning solution main tank of each unit of the electrospinning apparatus. In the first unit of the electrospinning apparatus, applied voltage is provided 15 kV, electrospinning the spinning solution on one side of a polyethylene terephthalate substrate of basis weight of 30 g/m², nanofiber non-woven fabric of thickness of 2.5 μm and fiber diameter of 250 nm. In the second unit of the electrospinning apparatus, applied voltage is provided 20 kV, electrospinning the spinning solution on the first polyvinylidene fluoride nanofiber non-woven fabric, and laminating formed a second polyvinylidene fluoride nanofiber non-woven fabric of thickness of 2.5 μm and fiber diameter of 130 nm. In this case, for electrospinning conditions, spinning solution flow rate is 0.1 mL/h, temperature 22° C., and humidity 20%. After electrospinning, in a laminating device located in the rear-end of the electrospinning apparatus, in the polyethylene terephthalate substrate of basis weight of 30 g/m², boding a polyethylene terephthalate substrate of basis weight of 100 g/m² on another side of the first polyvinylidene fluoride nanofiber non-woven fabric, and going through thermosetting in a laminating device, and finally produces a filter.

### EXAMPLE 38

Polyvinylidene fluoride resin for hot-melt of number average molecular weight of 3,000 is dissolved in N,N-Dimethylformamide (DMF) in 8 weight % and produces hot-melt solution, and it is inserted to a spinning solution main tank of a first unit of the electrospinning apparatus, and polyvinylidene fluoride of weight average molecular weight of 50,000 is dissolved in N,N-Dimethylacetamide (DMAc) and produces polyvinylidene fluoride solution, and it is inserted to a spinning solution main tank of a second and a third unit of the electrospinning apparatus. In the first unit of the electrospinning apparatus, electrospinning the hot-melt solution on one side of a polyethylene terephthalate substrate of basis weight of 30 g/m², and laminating formed hot-melt electrospinning layer of thickness of 1 μm. In the second unit, applied voltage is provided 15 kV, electrospinning the spinning solution on the hot-melt electrospinning layer, and laminating formed a first polyvinylidene fluoride nanofiber non-woven fabric of thickness of 2 μm and fiber diameter of 250 nm. In the third unit, applied voltage is provided 20 kV, electrospinning the spinning solution on the first polyvinylidene fluoride nanofiber non-woven fabric, and laminating formed a second polyvinylidene fluoride nanofiber non-woven fabric of thickness of 2 μm and fiber diameter of 130 nm. In this case, for electrospinning conditions, spinning solution flow rate is 0.1 mL/h, temperature 22° C., and humidity 20%. After electrospinning, in a laminating device located in the rear-end of the electrospinning apparatus, in the polyethylene terephthalate substrate of basis weight of 30 g/m², boding a polyethylene terephthalate substrate of basis weight of 100 g/m² on another side of the first polyvinylidene fluoride nanofiber non-woven fabric, and going through thermosetting in a laminating device, and finally produces a filter.

### COMPARATIVE EXAMPLE 21

The polyethylene terephthalate substrate of basis weight of 100 g/m² used in example 36 is used as filter medium.

### COMPARATIVE EXAMPLE 22

By laminating forming polyvinylidene fluoride nanofiber non-woven fabric which electrospun polyvinylidene fluoride on a polyethylene terephthalate substrate, and produces a filter.

Filtering efficiency of example 36 to 38 and comparative example 21 is measured according to the filtering efficiency measuring method and shown in Table 21.

TABLE 21

| | | | | Comparative |
|---|---|---|---|---|
| | Example 36 | Example 37 | Example 38 | Example 21 |
| 0.35 μm DOP | 92 | 90 | 91 | 70 |
| Filtering | | | | |
| efficiency (%) | | | | |

Also, pressure drop and filter life of a filter produced by example 37 and comparative example 21 are measured and shown in Table 22.

TABLE 22

| | Example 37 | Comparative Example 21 |
|---|---|---|
| Pressure drop | 4.6 | 7.8 |
| (in · w · g) | | |
| Filter life | 5.5 | 3.8 |
| (month) | | |

As described above, a filter comprising polyvinylidene fluoride nanofiber non-woven fabric and a bicomponent substrate produced by example 36 to 38, compared to comparative example 21, is excellent in filtering efficiency. Also, according to Table 22, a filter produced through example 37, compared to comparative example 21, has lower pressure drop which results in lower pressure lose and has longer filter sustainability which results in excellence in durability.

In result of measuring whether desorption or not of nanofiber non-woven fabric and a filter substrate of a filter produced by example 37 and 38 and comparative example 22 by the measuring method, in a filter produced by example 37 and 38 does not occur desorption of nanofiber non-woven fabric, but in a filter produced by comparative example 22 occurs desorption of nanofiber non-woven fabric.

Meanwhile, in the electrospinning apparatus (1″) according to an embodiment of the present invention, in the rear-end of a unit (10b) located in the rear-end, a laminating device (100) is provided, and a laminating device can be provided in both sides such as upper side and lower side of nanofiber non-woven fabric.

In other words, as illustrated in FIG. 32, the electrospinning apparatus (1″′) is provided a laminating device (100) in the rear-end of the unit (10b), and a substrate (not shown) is laminated to upper side and lower side of an elongated sheet (15) laminated nanofiber non-woven fabric.

Moreover, in an embodiment of the present invention, filter structure which laminated polyvinylidene fluoride on a bicomponent substrate laminated on a PET substrate is suggested, and on the polyvinylidene fluoride, melt blown fabric can be additionally provided.

According to the method as described above, in each unit (10a, 10b), after laminating forming polyvinylidene fluoride nanofiber non-woven fabric on a bicomponent substrate, and in a laminating device (100) located in the rear-end of the electrospinning apparatus (1), bonding a polyethylene terephthalate substrate on one side of the bicomponent substrate not laminating forming the polyvinylidene fluoride nanofiber non-woven fabric, and bonding melt blown non-woven fabric on polyvinylidene fluoride nanofiber non-woven fabric, going through a process of thermosetting in a laminating device (90), and produces a filter.

Here, in the process of electrospinning and laminating forming the polyvinylidene fluoride solution on a bicomponent substrate, by differing spinning conditions according to each unit (10a, 10b) of the electrospinning apparatus, in the first unit (10a), laminating forming polyvinylidene fluoride nanofiber non-woven fabric with large fiber diameter, and in the second unit (10b), polyvinylidene fluoride nanofiber non-woven fabric with small fiber diameter can be consecutively laminating formed.

### EXAMPLE 39

Polyvinylidene fluoride of weight average molecular weight of 50,000 is dissolved in N,N-Dimethylacetamide (DMAc) and produces spinning solution, and it is inserted to a spinning solution main tank of each unit of the electrospinning apparatus. In each unit, on a bicomponent substrate, electrospinning the spinning solution in conditions of the distance between an electrode and a collector is 40 cm, applied voltage 20 kV, spinning solution flow rate is 0.1 mL/h, temperature 22° C., and humidity 20%, and laminating formed polyvinylidene fluoride nanofiber non-woven fabric of thickness of 3 μm. The bicomponent substrate is Sheath-Core type, and basis weight is 30 g/m². After electrospinning, bonding a polyethylene terephthalate on one side of a bicomponent substrate, and after boding melt blown non-woven fabric on laminated polyvinylidene fluoride nanofiber non-woven fabric, going through thermosetting, and produces a filter. The polyethylene terephthalate substrate basis weight is 100 g/m², and the melt blown non-woven fabric basis weight is 30 g/m².

### EXAMPLE 40

High melting point polyvinylidene fluoride of weight average molecular weight of 50,000 and low melting point polyvinylidene fluoride is dissolved in N,N-Dimethylacetamide (DMAc) and produces spinning solution, and it is inserted to a spinning solution main tank of each unit of the electrospinning apparatus. In each unit, on a bicomponent substrate, electrospinning the spinning solution in conditions of the distance between an electrode and a collector is 40 cm, applied voltage 20 kV, spinning solution flow rate is 0.1 mL/h, temperature 22° C., and humidity 20%, and laminating formed polyvinylidene fluoride nanofiber non-woven fabric of thickness of 3 μm. The bicomponent substrate is Sheath-Core type, and basis weight is 30 g/m². After electrospinning, bonding a polyethylene terephthalate on one side of a bicomponent substrate, and after boding melt blown non-woven fabric on laminated polyvinylidene fluoride nanofiber non-woven fabric, going through thermosetting, and produces a filter. The polyethylene terephthalate substrate basis weight is 100 g/m², and the melt blown non-woven fabric basis weight is 30 g/m2.

### COMPARATIVE EXAMPLE 23

The polyethylene terephthalate substrate used in example 39 is used as filter medium.

### COMPARATIVE EXAMPLE 24

By laminating forming polyvinylidene fluoride nanofiber non-woven fabric which electrospun polyvinylidene fluoride on a polyethylene terephthalate substrate, and produces a filter.

Filtering efficiency of example 39 and 40 and comparative example 23 is measured according to the filtering efficiency measuring method and shown in Table 23. Also, pressure drop and filter sustainability of a filter produced by example 39 and 40 and comparative example 23 are measured and shown in Table 24.

TABLE 23

| | Example 39 | Example 40 | Comparative Example 23 |
|---|---|---|---|
| 0.35 μm DOP | 92 | 91 | 63 |
| Filtering | | | |
| efficiency (%) | | | |

TABLE 24

| | Example 39 | Example 40 | Comparative Example 23 |
|---|---|---|---|
| Pressure drop | 4.1 | 4.0 | 5.2 |
| (in · w · g) | | | |
| Filter life | 6.1 | 6.3 | 3.8 |
| (month) | | | |

As described above, a filter additionally provided melt blown non-woven fabric produced by example 39 and 40, compared to comparative example 23, is excellent in filtering efficiency.

Also, according to Table 24, a filter produced through example 39 and 40, compared to comparative example 23, has lower pressure drop which results in lower pressure lose and has longer filter sustainability which results in excellence in durability.

In result of measuring whether desorption or not of nanofiber non-woven fabric and a filter substrate of a filter produced by example 39 and 40 and comparative example 24 by the measuring method, in a filter produced by example 39 and 40 does not occur desorption of nanofiber non-woven fabric, but in a filter produced by comparative example 24 occurs desorption of nanofiber non-woven fabric.

While this invention has been described in connection with what is presently considered to be practical exemplary embodiments, it is to be understood that the invention is not limited to the disclosed embodiments, on the contrary, is intended to cover various modifications and equivalent arrangements included within the spirit and scope of the appended claims.

1-42. (canceled)

43. A filter comprising nanofiber, comprising:
a substrate; and
nanofiber non-woven fabric laminated on the substrate by electrospinning polymer solution, the substrate and the nanofiber non-woven fabric are thermosetted each other.

44. The filter comprising nanofiber of claim 43,
wherein the substrate is formed with a single-layer or two or more laminated layers, and is one or two or more selected from among a group consisting of cellulose substrate, bicomponent substrate and polyethylene terephthalate substrate.

45. The filter comprising nanofiber of claim 44,
wherein the cellulose substrate comprises cellulose and polyethylene terephthalate, and the composition ratio of the cellulose is 70 to 90 mass %, and the polyethylene terephthalate composition ratio is 10 to 30 mass %.

46. The filter comprising nanofiber of claim 43,
wherein the nanofiber non-woven fabric is formed with a single-layer or two or more laminated layers, wherein the polymer solution is one or two or more selected from among a group consisting of polyvinylidene fluoride, polyurethane, nylon and hot-melt.

47. The filter comprising nanofiber of claim 46,
wherein the polyvinylidene fluoride comprises one or two selected from among a group consisting of low melting point polyvinylidene fluoride and high melting point polyvinylidene fluoride.

48. The filter comprising nanofiber of claim 46,
wherein the polymer solution is mixed with polymer and hot-melt.

49. The filter comprising nanofiber of claim 46,
wherein the hot-melt is one selected from among a group consisting of polyvinylidene fluoride group hot-melt, polyurethane group hot-melt and polyamide group hot-melt.

50. The filter comprising nanofiber of claim 46,
wherein the nanofiber non-woven fabric is formed with two-layers of which a nylon nanofiber non-woven fabric with fiber diameter of 100 to 150 nm laminated by electrospinning on the substrate, and a polyvinylidene fluoride nanofiber non-woven fabric with fiber diameter of 80 to 150 nm laminated by electrospinning on the nylon nanofiber non-woven fabric.

51. The filter comprising nanofiber of claim 46,
wherein the nanofiber non-woven fabric is formed with two-layers of which a first nanofiber non-woven fabric with fiber diameter of 150 to 300 nm laminated by electrospinning on the substrate, and a second nanofiber non-woven fabric with fiber diameter of 100 to 150 nm laminated by electrospinning on the first nanofiber non-woven fabric.

52. The filter comprising nanofiber of claim 46,
wherein the nanofiber non-woven fabric is formed with three-layers of which a first nanofiber non-woven fabric of fiber diameter of 200 to 250 nm laminated by electrospinning on the substrate, a second nanofiber non-woven fabric of fiber diameter of 150 to 200 nm laminated by electrospinning on the first nanofiber non-woven fabric, and a third nanofiber non-woven fabric of fiber diameter of 100 to 150 nm laminated by electrospinning on the second nanofiber non-woven fabric.

53. The filter comprising nanofiber of claim 43,
wherein the nanofiber non-woven fabric further comprises a meltblown non-woven fabric laminated thereon.

54. A method for manufacturing filter comprising nanofiber, by the electrospinning apparatus comprises 2 or more units, spinning solution main tank is independently connected and installed in nozzle of nozzle block located in each unit, and polymer spinning solution is spun on a substrate located in a collector of each unit, comprising:
a step of inserting polymer solution which dissolved polymer in solvent to spinning solution main tank in each unit;
a step of laminating forming nanofiber non-woven fabric by consecutively electrospinning polymer solution on the substrate in each unit; and
a step of thermosetting the substrate and the nanofiber non-woven fabric.

55. The method for manufacturing filter comprising nanofiber of claim 54, wherein the substrate is formed with a single-layer or two or more laminated layers, and contains one or two or more selected from among a group consisting of cellulose substrate, bicomponent substrate and polyethylene terephthalate substrate.

56. The method for manufacturing filter comprising nanofiber of claim 54, wherein the polymer solution spun in each unit is different or identical to each other, and the polymer solution comprises one or two or more selected from among a group consisting of polyvinylidene fluoride, polyurethane, nylon and hot-melt.

57. The method for manufacturing filter comprising nanofiber of claim 56, wherein the polyvinylidene fluoride comprises one or two selected from among a group consisting of low melting point polyvinylidene fluoride and high melting point polyvinylidene fluoride.

58. The method for manufacturing filter comprising nanofiber of claim 56, wherein the polymer solution is mixed with polymer and hot-melt.

59. The method for manufacturing filter comprising nanofiber of claim 56, wherein the hot-melt comprises one selected from among a group consisting of polyvinylidene fluoride group hot-melt, polyurethane group hot-melt and polyamide group hot-melt.

60. The method for manufacturing filter comprising nanofiber of claim 54, wherein the step of laminating-forming the nanofiber non-woven fabric comprises:
a step of laminating-forming a first nanofiber non-woven fabric with fiber diameter of 150 to 300 nm in a first unit of the electrospinning apparatus; and
a step of laminating-forming a second nanofiber non-woven fabric with fiber diameter of 100 to 150 nm in a second unit of the electrospinning apparatus.

61. The method for manufacturing filter comprising nanofiber of claim 54, wherein the step of laminating-forming the nanofiber non-woven fabric comprises:
a step of producing nylon solution by dissolving nylon in solvent and producing polyvinylidene fluoride solution by dissolving polyvinylidene fluoride in solvent;
a step of laminating-forming nylon nanofiber non-woven fabric with fiber diameter of 100 to 150 nm by electrospinning the nylon solution on a substrate in a first unit of the electrospinning apparatus; and
a step of laminating-forming polyvinylidene fluoride nanofiber non-woven fabric with fiber diameter of 80 to 150 nm by electrospinning the polyvinylidene fluoride solution on the nylon nanofiber non-woven fabric in a second unit of the electrospinning apparatus.

62. The method for manufacturing filter comprising nanofiber of claim 54 further comprises a step of laminating-forming a meltblown non-woven fabric on the nanofiber non-woven fabric.
